(19) United States
(12) Patent Application Publication
(10) Pub. No.: US 2025/0151736 A1
(43) Pub. Date: May 15, 2025

(54) HEALTHY SANDWICH PRODUCT AND METHOD FOR PREPARATION

(71) Applicants: Albert Long Trinh, Cincinnati, OH (US); Dennis Sam Trinh, Cincinnati, OH (US); Toan Trinh, Maineville, OH (US)

(72) Inventors: Albert Long Trinh, Cincinnati, OH (US); Dennis Sam Trinh, Cincinnati, OH (US); Toan Trinh, Maineville, OH (US)

(21) Appl. No.: 19/022,362

(22) Filed: Jan. 15, 2025

Related U.S. Application Data
(63) Continuation of application No. 16/147,933, filed on Oct. 1, 2018.
Application No. 16/147,933 is a continuation of application No. 14/942,220, filed on Nov. 16, 2015, now abandoned.
Application No. 14/942,220 is a continuation-in-part of application No. PCT/US2014/038123, filed on May 15, 2014.
(60) Provisional application No. 61/855,396, filed on May 15, 2013.
(60) Provisional application No. 62/079,776, filed on Nov. 14, 2014.
(60) Provisional application No. 62/079,791, filed on Nov. 14, 2014.

(51) Int. Cl. A21D 13/38; A21D 13/32; A21D 13/33; A23L 5/30; A23L 13/60; A23L 19/00; A23L 35/00; A23P 20/20

(52) U.S. Cl. CPC A21D 13/38; A21D 13/32; A21D 13/33; A23L 5/34; A23L 13/60; A23L 19/05; A23L 35/00; A23P 20/20

(57) ABSTRACT

New sandwich product, particularly a fast food sandwich product that contains appreciable amounts of salad ingredients, and to a salad insert suitable for use in such sandwich product to improve the diet of the consumer. The sandwich product can include a layer of a meat or protein portion with the layer of a wrapped salad portion that are placed on or enclosed between a bread portion. The wrapped salad portion uses an edible wrapper to enclose the salad ingredients. The edible wrapper can be an edible processed wrapper such as rice paper or soy paper, or an edible natural wrapper such as a lettuce leaf or cabbage leaf, or a combination thereof. An edible humectant can be used in the source of water used for moistening a dried sheet of a rice paper for improving the resistance to drying of a moistened rice paper. Salad dressing can be injected through the outer layer of the wrapped salad portion using a needle.

### CROSS-REFERENCE TO RELATED APPLICATIONS

This application is a continuation of U.S. Non-provisional application Ser. No. 16/147,933 filed Oct. 1, 2018, which is a continuation of U.S. Non-provisional application Ser. No. 14/942,220 filed Nov. 16, 2015, which is a continuation-in-part of International Application No. PCT/US2014/038123 filed May 15, 2014, which claims the benefit of U.S. Provisional Application 61/855,396 filed May 15, 2013, and claims the benefit of U.S. Provisional Applications 62/079,776 filed Nov. 14, 2014, and 62/079,791 filed Nov. 14, 2014, the disclosures of which are incorporated by reference in their entireties.

### FIELD OF INVENTION

This invention relates to a sandwich product, particularly fast food sandwich products that contain appreciable amounts of salad ingredients and to salad inserts suitable for use in such sandwich products.

### BACKGROUND OF THE INVENTION

The most popular fast food sandwich product is hamburger which typically comprises a cooked patty of ground meat that is placed inside a sliced bread roll or hamburger bun. Examples of large fast food chains that sell hamburger sandwiches include McDonald's®, Burger King®, Wendy's®, and White Castle®. Most chains also sell chicken sandwiches, fish sandwiches, and ham sandwiches. Another common fast food sandwich is the roast beef sandwich which comprises sliced roast beef or sliced roast turkey placed inside a sliced bread roll. The largest roast beef sandwich chain is Arby's®. The sandwich products are often served with one or more slices of cheese and are typically high in calories and low in nutrients, even with the addition of some lettuce, onions, pickles, and/or tomatoes, etc. Examples of sandwich products that contain lettuce are McDonald's Big Mac® and McChicken® sandwiches that contain shredded iceberg lettuce, and McDonald's Premium Crispy Chicken Classic sandwich that contain leaf lettuce. Generally the fast food sandwiches are eaten without utensils, either held in the consumer's hands, or are held in a wrapping paper to consume.

Excess consumption of fast foods is believed to contribute to the current obesity epidemic. A recent research article published in the American Journal of Preventive Medicine (K. W. Bauer, et al, Am J Prev Med. 2012 November; 43 (5): 490-7) reiterates that “(s)tudies have consistently found positive associations between fast-food intake and excess weight gain among adults,” and reports that between 1997 and 2010, “Although large increases in the number of menu items were observed, there have been few changes in the energy content of menu offerings at the leading fast-food chain restaurants examined in this study.” and more specifically, “it appears that the median energy content of restaurant menus has been stable for menus overall, entrées, and drinks, increasing for condiments and desserts, and decreasing for side items.” Due to their appealing taste, fast food products are widely served and consumed in school and college cafeterias where many people tend to develop poor eating habits. It is desirable to have a more nutritionally balanced product, but the number of ingredients that can be incorporated to a sandwich is somewhat limited by the fact that the bun or bread slices do not hold and control many ingredients well. As a result, the products tend to be messy to eat with the primary approach to solving this problem being the use of a paper/plastic wrapper. The products are consumed not only while sitting down in a restaurant or cafeteria, but also in other locations such as in automobiles and buses while on trips.

In order to have a more balanced meal, the fast food sandwiches, such as hamburgers, can be eaten along with a separate side salad. For example, McDonalds's sells a side salad containing about 87 g lettuce, cherry tomatoes and thinly sliced carrots, while Burger King sells a “garden side salad” with about 90 to about 100 g salad and about 50 g salad dressing. The addition of a salad requires separate utensils and makes it very difficult to eat the meal as “carry out” food unless the customer provides a separate seat/table arrangement which then means any mess needs to be cleaned up after the meal.

Alternative fast food products that can provide more vegetable and salad ingredients are the submarine sandwiches, or the “subs,” that are sold, most notably by the Subway® chain. Since the bread of the sandwich is only half opened, with the two sliced parts of the elongated bread still linked or hinged on one side, this type of sandwiches can hold and control more salad ingredients. Even with a better ability to hold ingredients, eating a Subway sandwich is still fairly untidy, with salad ingredients falling out of the sandwich into the wrapping paper or onto the table or floor.

Other fast foods that contain salad ingredients do away with the sandwich bread or roll altogether. One type of such products is the taco, which comprises of a hard shell or soft round corn or wheat tortilla that is folded in halves to contain a variety of fillings, most commonly comprising a meat ingredient, such as chopped, ground, or sliced cooked beef, chicken, pork, or seafood, that is garnished with cheese, sliced lettuce, chopped tomatoes, onions, cilantro, avocado, and a sauce, such as salsa or guacamole. The largest taco chain is Taco Bell®. Such products with open shells are even more difficult to eat without creating a mess. A variation of the taco is a wrap, commonly called a sandwich wrap, wherein the filling is arranged across a soft tortilla and rolled into an elongated tube filled typically with similar taco ingredients. Even though it is call a sandwich wrap, a sandwich wrap and a sandwich are different. A sandwich has two distinct bread layers, which are the top and bottom buns or pieces of bread. A sandwich wrap, on the other hand, comprises one piece of soft unleavened bread, commonly unleavened cornmeal bread, which completely surrounds the content or the filling of the wrap into an elongated cylindrical form with open ends. Burritos are similar and are believed to be the model for the sandwich wrap; burritos are also elongated tube wraps, but with closed ends. The sandwich wraps typically contain a tortilla covering that is fairly substantial part of the product. Taco Bell and other restaurants sell sandwich wraps.

Variation of tacos and sandwich wraps can be found in Oriental cuisine. A Vietnamese form of taco comprises a lettuce leaf folded in half to contain a filling of cooked pork, chicken, shrimp, or fish, garnished with some salad ingredients, cooked rice noodle, and fresh herbs. The lettuce leaf can also be used to loosely wrap around the filling into a loose elongated roll with open ends that allows a consumer to hold the roll with one hand, and to dip the roll in a sauce. Another Vietnamese variation of a roll is replacing the lettuce leaf with a softened rice paper to wrap around fillings in an elongated cylindrical form comprising cooked meat, or sea food, lettuce and other vegetable trimmings, cooked rice noodle, and herbs, and are known as goi cuon (rolled salad). A Korean wrap version is called bossam that uses a leaf of celery cabbage, napa cabbage, or lettuce as the wrapping material and a filling traditionally comprising cooked pork, raw oyster, and kimchi. Commonly, the leaf is hold open in the palm of one's hand with the concave side facing up like a cup or a bowl, with the filling placed in that vegetable cup for consumption. The leaf can also be loosely rolled into a wrap that is held in one hand for easier dipping in a sauce.

These alternative foods may be healthier, but the favorite fast foods, especially for children and adolescents remain the fast food sandwiches, such as hamburger sandwiches. It is desirable to be able to incorporate a larger amount of salad, comprising lettuce and other savory salad ingredients into these favorite sandwiches, to increase the balance between the vegetable ingredients and the meat ingredients, in order to improve public health. A sandwich with good containment of savory salad ingredients is essential for providing good taste and improving the diet habits of a large portion of the population. It is much more convenient to consume such a combined sandwich instead of having to eat a sandwich and a salad separately, which requires additional utensils for the separate salad. However, many savory salad ingredients that are essential to improving the acceptance of these healthier products are normally finely divided ingredients, such as, shredded carrots, chopped onion, chopped scallions, chopped cilantro, sliced bell pepper, sliced jalapeños, olives, mushroom, chopped boiled egg, cherry tomatoes, raisins, grated cheese, shredded cheese, bacon bits, green peas, garbanzo beans, bean sprouts, and dressings or sauces. A simple addition of a large amount of these finely divided ingredients between the two slices of a sandwich bun will cause a spillover of the salad ingredients onto the hands and the environment while the product is being consumed.

One approach to containing additional ingredients is found in published US patent application US 2010/0260897, Schoen, (Oct. 14, 2010) which provides a bakery bun product with raised sides form a cup to hold the extra ingredients and to minimize the leakage of these ingredients out the sides of the bun. However, considering the softness of the bun material, either the sides are necessarily thick, making the inside container fairly small, or the sides are thin and cannot hold the extra ingredients.

Therefore, even after billions and billions of sandwiches that have been sold in fast food restaurants and school cafeterias, there still is a need to create a sandwich product, especially in the popular hamburger bun form, that can contain a substantial amount of healthy and savory salad ingredients without spillage or leakage to improve the diet of the consumer, especially young consumer. The salad portion in such sandwich product can be of a preselected recipe or more preferably the salad comprises ingredients that are selected by each consumer to best suit their individual taste and preference, in order to encourage them to consume the nutritiously desirable vegetable at the same time with the traditional fast food meal. The present invention provides a method to increase the ability to incorporate healthy salad ingredients into fast food sandwiches that can be handled by hand(s), while at the same time providing the convenience for consuming such healthy salad ingredients without the need for utensils such as a fork and/or knife, and reducing the messy nature of the product.

### SUMMARY OF THE INVENTION

This invention relates to a sandwich product, especially a fast food sandwich product, that contains appreciable amounts of salad ingredients to improve the diet of the consumer, wherein the sandwich product comprises a meat or protein portion layer and a wrapped salad portion layer that are placed on or enclosed between a bread portion, wherein said wrapped salad portion comprises an edible wrapper enclosing one or more salad ingredients The invention also comprises the methods for preparing the said sandwiches and said wrapped salad portion.

The edible wrapper is selected from processed edible wrappers and natural edible wrappers. The preferred processed edible wrapper is selected from rice paper and soy paper, preferably rice paper. The preferred natural edible wrappers are lettuce leaves including iceberg lettuce leaves, and cabbage leaves, preferably iceberg lettuce leaves. The wrapped salad portion is in the form of an approximately square or an approximation of a round form. The wrapper contains a salad ingredient mixture, with the edges of the wrapper folded over and overlapped one another to fully enclose the salad mixture.

The bread portion can include one or more slices of bread, including at least two slices of bread, a sliced hamburger bun with a bottom part and a top part, or a sliced hamburger bun and a middle slice of bread.

The sandwich product can optionally include a salad dressing. The sandwich product can optionally comprise some salad ingredients that are outside the wrapped salad portion. And the meat or protein portion can optionally include one or more salad ingredients that are outside the wrapped salad portion.

The wrapped salad portion preferably has the form of a flattened mass having an approximately square form or an approximation of a round form, in the shape of a substantially thick square or round hamburger patty. The formation of such a relatively “squat” square or round shape that keeps the ingredients from leaking is more difficult than when forming a longer cylindrical wrap whose diameter is much shorter than the length of the cylinder and whose opening is therefore much smaller and easier to seal.

The salad ingredients are selected from: chopped lettuce, cut up lettuce, shredded lettuce, wherein lettuce is selected from iceberg lettuce, green romaine lettuce, red romaine lettuce, green leaf lettuce, red leaf lettuce, Boston lettuce, and mixture thereof; fresh spinach, chopped fresh spinach, fresh baby spinach leaves; spring mix comprising one or more of baby red romaine, baby green romaine, baby red leaf, baby green leaf, baby red Swiss chard, baby red oak, baby green oak, parella, lolla rosa, tango, tot soi, arugula, mizuma, radicchio, or frisee; edible dandelions; shredded green cabbage, shredded red cabbage, shredded savoy cabbage; shredded carrots, thinly sliced carrots; cut up celery; sliced cucumber; chopped onion; sliced onion; chopped green onion (or chopped scallions); sliced radishes; shredded radishes; chopped cilantro; chopped mints; chopped basil; sliced dill pickles; sliced bell pepper selected from sliced green bell pepper, sliced red bell pepper, sliced yellow bell pepper, red pepper, and mixtures thereof; jalapeño slices; olives selected from sliced black olives, pepper-stuffed green olives, and mixtures thereof; sliced or chopped fresh mushroom; chopped boiled egg, tomatoes selected from chopped tomatoes, cherry tomatoes, grape tomatoes, sun-dried tomatoes, boiled corn kernels; sliced roasted tomatoes, and mixtures thereof; garlic or roasted garlic; seedless grapes; raisins; maraschino cherries; chopped pineapple; cheese selected from grated cheese, grated parmesan cheese, shredded cheddar cheese, shredded mozzarella cheese, blue cheese crumbs, and mixtures thereof; green peas; garbanzo beans or chick-peas; red beet slices; bean sprouts; broccoli pieces; cauliflower pieces; cut up asparagus; bacon bits, seeds and nuts selected from sunflower kernels, chopped pistachios, sliced toasted almonds, pecan, walnuts, pumpkin seeds, and mixtures thereof; prepared meat selected from chopped sausage, chopped bologna, chopped ham, chopped chicken, and mixtures thereof; thick sauce; creamy sauce; salad dressing; and mixtures thereof.

The bread portion and the meat or protein portion of the sandwich product of the present invention comprise components of typical sandwiches that are sold in fast food restaurants, typically comprising hamburger sandwich; cheese burger (hamburger sandwich with one or more slices or a layer of cheese); chicken sandwich; fish sandwich; ham sandwich and ham sandwich with cheese; turkey sandwich; sliced roast beef sandwich; sliced roast beef with cheese; sliced roast turkey; sliced roast turkey with cheese; egg, ham, sausage, and cheese muffin sandwiches; egg, ham, sausage, and cheese croissant sandwiches; veggie burger with textured vegetable (soy) protein patties; and the like, and variations thereof.

The present invention also relates to a sandwich product combining a meat or protein portion layer and a wrapped salad portion layer that are enclosed between a bread portion, wherein the wrapped salad portion layer comprises an edible wrapper enclosing one or more salad ingredients.

The present invention also relates to a wrapped salad insert to be placed inside a sandwich, especially a fast food sandwich, to improve the diet of the consumer, wherein the wrapped salad insert comprises an edible wrapper enclosing salad ingredients. The edible wrapper is selected from: rice paper, lettuce leaves, cabbage leaves, and combinations thereof and is in the form of a square or approximation of a round form. The wrapper contains the salad ingredient mixture. The wrapped salad insert preferably has the form of a flattened mass having an approximately square form or an approximation of a round form, in the shape of a substantially thick square or round hamburger patty. The fast food sandwich using the wrapped salad insert of the present invention can include typical sandwiches that are sold in fast food restaurants, typically hamburger sandwich; cheese burger (hamburger sandwich with cheese); chicken sandwich; fish sandwich; ham sandwich and ham sandwich with cheese; turkey sandwich; sliced roast beef sandwich; sliced roast beef with cheese; sliced roast turkey; sliced roast turkey with cheese; egg, ham, sausage, and cheese muffin sandwiches, egg, ham, sausage, and cheese croissant sandwiches; veggie burger with textured vegetable (soy) protein patties; and the like, and variations thereof. The fast food sandwich can optionally comprise some salad ingredients that are outside the wrapped salad insert, and the wrapped salad ingredient mixture optionally but preferably includes a salad dressing, with the edges of the edible wrapper folded over and overlapping one another to fully enclose the salad ingredient mixture.

The present invention also relates to a method for preparing a wrapped salad portion, comprising the steps: (1) placing a first edible wrapper on a flat or concave surface of a template; (2) placing a plurality of salad ingredients into a heap in a middle portion of the first edible wrapper; (3) optionally adding a salad dressing to the salad ingredients; (4) folding at least one edge of the first edible wrapper over the salad ingredients, to fully enclose the salad ingredients within the edible wrapper to form the wrapped salad portion; and (5) releasing the wrapped salad portion from the template.

The present invention further relates to a method for loosening and safely removing the iceberg lettuce leaves from a lettuce head comprises at least one of the steps of: (1) coring the central stem to which the leaves are attached using a sharp pointed and thin-bladed serrated knife, a powered long drill bit, or other sharp bladed devices to cut a cone shaped portion of the central stem to release the leaves; (2) heating the whole head of lettuce whose central stem has been removed in a microwave oven at full power for about 30 sec to about 1 min to make the outside leaves warm and somewhat softened and more resilient, but not completely wilted, and optionally still crunchy enough to be readily bitten; (3) removing about two or four leaves as treated in step (2) one by one from the lettuce head; (4) heating the lettuce head resulting from step (3) as in step (2); and (5) repeating the method until all the suitable leaves for forming a wrap are removed.

The present invention further relates to a wrapped sandwich product, especially a fast food wrapped sandwich product, to improve the diet of the consumer, wherein the wrapped sandwich product comprises an edible wrapper enclosing one or more salad ingredients and a meat or protein portion, and optionally but preferably a salad dressing. The edible wrapper is selected from: rice paper, lettuce leaves, cabbage leaves, and combinations thereof and is in the form of a square or approximation of a round form. The edible wrapper contains the one or more salad ingredients or a mixture thereof, and the meat or protein portion, with the edges of the edible wrapper folded over and overlapped one another to fully enclose the salad ingredients and the meat or protein portion. The wrapped sandwich product preferably has the form of a flattened mass having an approximately square form or an approximation of a round form, in the shape of a substantially thick square or round hamburger patty. The meat or protein portion can include a hamburger patty, a chicken fillet, a fish fillet, a ham portion, a turkey portion or slices, sliced roast beef, sliced roast turkey, a sausage portion, and a “protein” portion comprising a soy protein patty. The meat or protein portion can be combined with a separate slice or layer of cheese or a separate egg portion. The wrapped sandwich product is self-contained and can be handled by hand(s) without the need for utensils such as a fork and/or a knife. The wrapped sandwich product can optionally include a bread portion that is placed around the wrapped sandwich product, or placed therein.

The present invention also relates to a dually- or twice-wrapped sandwich product wherein the wrapped sandwich product comprises an inner layer of an iceberg lettuce wrapper containing and enclosing a salad ingredient mixture and an optional meat or protein portion, and an outer layer of a softened rice paper that envelops and overlaps the iceberg lettuce wrapper. In this twice-wrapped sandwich product, the lettuce layer provides the strength and the softened rice paper layer provides the resiliency and integrity of the wrapped sandwich product.

The present invention also relates to a wrapped salad portion or wrapped sandwich product comprising an edible natural wrapper that contains salad ingredients and optional salad dressing, and an optional meat or protein portion, contained within the edible natural wrapper, especially a fast food wrapped sandwich product, to improve the diet of the consumer. The wrapped sandwich product includes a portion of an edible processed wrapper, as a sticker or patch of an edible processed film, disposed over the overlapped ends of the edible natural wrapper, to retain the edible contents within the edible natural wrapper. The adherence of the portion of edible processed wrapped can be enhanced by applying a natural edible adhesive to the interface surface or a contact side of the portion of edible processed wrapper and the natural edible wrapper. The natural edible adhesive can include an aqueous liquid or paste. Typically the portion of edible processed wrapper is a smaller area portion than when used as a sandwich wrapper. The contact side of the edible processed wrapper sticker or patch is applied to the top of the wrapped salad portion to hold the exposed lettuce leaf wrapper edges in place. The sticker can be made of any flexible edible thin sheet, preferably it is made of a thin wrapper material of less than about 1 mm in thickness, preferably selected from softened rice paper or soy paper, preferably softened rice paper. The sticker is preferably made with a piece of rice paper wrapper, such as a quarter of a 25-cm-diameter round rice paper wrapper, more preferably the rice paper sticker is of approximately round form of about 6 cm to about 12 cm in diameter. The edible aqueous binder fluid or paste comprises a gum powder, such as xanthan gum powder, guar gum powder, and mixtures thereof.

An invention also includes the use of a wax paper or similar release film or paper, placed under, over or between adjacent rice paper wrapper sheets, wrapped salad portions, or wrapped sandwich products, to prevent sticking or to improve handling in the assembly or storage of the finished wrapped ingredient or product.

An invention also includes the use of an edible humectant in the source of water used for moistening rice papers, to improve their resistance to drying, and to reduce or prevent stiffening and cracking by the loss of moisture from the rice paper after forming of the wrapped salad portion or wrapped sandwich product. The invention can include a method comprising a step of adding an edible humectant into a source of water used for moistening a dried sheet of a rice paper, and moistening the rice paper in the source of water comprising the edible humectants. The present invention also provides a wrapped salad portion comprising salad ingredients and a thin, edible wrapper enclosing the salad ingredients, the edible wrapper comprising a moistened rice paper comprising an edible humectant.

The present invention also provides a method is provided for preparing a wrapped salad portion or wrapped sandwich product, comprising the steps: (1) providing a moistened rice paper comprising the edible humectant, optionally onto a flat or concave surface of a template; (2) placing a plurality of salad ingredients into a heap in a middle portion of the moistened rice paper; (3) optionally adding a salad dressing to the salad ingredients; (4) folding an edge of the moistened rice paper over the salad ingredients, to fully enclose the salad ingredients within the moistened rice paper to form the wrapped salad portion; and optionally (5) releasing the wrapped salad portion from the template.

In an alternative invention, the finished wrapped salad portions or wrapped sandwich products can be stored within a humidifier, to improve their resistance to drying, and to reduce or prevent stiffening and cracking by the loss of moisture from the rice paper after forming of the wrapped salad ingredients or wrapped sandwich product.

Another invention is the use of nitrile gloves for use in a method of preparing and handling of softened rice papers and wrapped salad portions and wrapper sandwich products made therewith.

In another aspect of the invention, a method is provided for placing a volume of salad dressing into a wrapped salad portion or wrapped sandwich product. The method includes the steps of a. providing an injector device comprising at least one needle including a tip and at least one lateral port near the tip, wherein the injector device contains a salad dressing; b. inserting the tip of the at least one needle of the injector device into the wrapped salad portion or wrapped sandwich product; c. expressing a volume of the salad dressing from the injector device through the at least one lateral port to the interior of the wrapped salad portion or wrapped sandwich product; and d. removing the at least one needle from the wrapped salad portion or wrapped sandwich product.

The invention also provides a multi-needle injector device, comprising a cylinder, a plunger assembly including a plunger moveable along the interior length of the cylinder, and a multi-needle device including an inlet port attached to the cylinder, and a plurality of needles in fluid communication with the inlet port, each needle having a tip and at least one lateral port near the tip.

The invention further provides a method for placing a volume of salad dressing into a sealed and wrapped salad portion or wrapped sandwich product using the multi-needle injector device, and comprises the steps of: a. inserting the plurality of needles through the top side of the wrapped salad portion or wrapped sandwich product; b. expressing a volume of the salad dressing from the plurality of needles to the interior of the wrapped salad portion or wrapped sandwich product; and c. removing the plurality of needles from the wrapped salad portion or wrapped sandwich product.

### BRIEF DESCRIPTION OF THE DRAWINGS

The invention will be more clearly understood from the following detailed description of representative embodiments thereof in conjunction with the accompanying drawing figures herein.

FIG. 1 shows an exploded perspective view of the elements needed to prepare a wrapped salad portion with two softened round rice papers, with the second softened round rice paper still being separated.

FIG. 2 shows a cross-sectional view of the elements of FIG. 1.

FIG. 3 shows the cross-sectional view of FIG. 2, with the second softened round rice paper now being laid on top of the salad ingredient mixture.

FIG. 4 shows a cross-sectional view of the separated round wrapped salad portion patty.

FIG. 5 shows a cross-sectional view of the elements needed to prepare a wrapped salad portion with two softened round rice papers of significantly different sizes, with the second and smaller freshly softened round rice paper still being separated.

FIG. 6 shows the cross-sectional view of FIG. 5, with the second round rice paper 203 now being laid on top of the salad ingredient mixture.

FIG. 7 shows a cross-sectional view of the separated round wrapped salad portion patty.

FIG. 8 shows a section view of a wrapped sandwich product containing a meat patty therein.

FIG. 9 shows a plan view of a flap wrapper for use in making a wrapper product.

FIG. 10 shows a cross-sectional view of the elements needed to prepare a wrapped salad portion with the flap wrapper of rice paper and a lettuce leaf as a natural wrapper between the rice paper wrapper and a salad ingredient mixture and a salad dressing.

FIG. 11 shows the cross-sectional view of FIG. 10, with flap portion of the flap wrapper now laid over the top of the salad ingredient mixture.

FIG. 12 shows the cross-sectional view of FIG. 11, with the opposed edge of the main circular portion of the flap wrapper laid over top of the flap portion, to enclose the salad ingredient mixture.

FIG. 13 shows a cross-sectional view of the separated round wrapped salad portion patty.

FIG. 14 shows a cross-sectional view of a hamburger including a wrapped salad portion, a meat or protein portion, and two bread buns.

FIG. 15 shows a perspective view of the elements needed to prepare a wrapped salad portion with one large, softened round rice paper.

FIG. 16 shows a cross-sectional view of the elements of FIG. 15.

FIG. 17 shows the cross-sectional view of FIG. 16, with the round rice paper over on top of the salad ingredient mixture, and separated from the preparation dish.

FIG. 18 shows a cross-sectional view of the elements needed to prepare a wrapped salad portion with one large, softened round rice paper and a lettuce leaf as an edible natural wrapper between the rice paper and a salad ingredient mixture and a salad dressing.

FIG. 19 shows the cross-sectional view of FIG. 18, with the round rice paper over on top of the salad ingredient mixture, and separated from the preparation dish.

FIG. 20 shows a cross-sectional view of the elements needed to prepare a wrapped salad portion with a salad ingredient mixture enclosed in a lettuce leaf as an edible natural wrapper, and a portion of a processed wrapper sealed over the edges of the lettuce leaf.

FIG. 21 shows a cross-sectional view of a twice-wrapped sandwich product with a salad ingredient mixture and a salad dressing with a lettuce leaf as an inner wrapper layer and a softened rice paper as an outer wrapper layer.

FIG. 22 shows a cross-sectional view of a twice-wrapped sandwich product with a salad ingredient mixture, a salad dressing and a meat patty, with a lettuce leaf as an inner wrapper layer and softened rice papers as an outer wrapper layer.

FIG. 23 shows a nitrile glove for use in a method of the invention for handling moistened rice papers and wrapped salad portions and wrapped sandwich products made therefrom.

FIG. 24 shows a cross-sectional view of a wrapped salad portion, and a device for injecting a salad dressing within the wrapped salad portion.

FIG. 25 shows the injection device inserted into and injecting salad dressing within the wrapped salad portion.

FIG. 26 shows an injection device having multiple needles.

These drawings are not drawn to scale and are intended for illustrative purposes only.

### DETAILED DESCRIPTION OF THE INVENTION

This invention relates to a food product, typically a sandwich product, especially a fast food sandwich product, that contains appreciable amounts of salad ingredients to improve the diet of the consumer, wherein the sandwich product comprises a meat or protein portion layer and a self-contained wrapped salad portion layer that are enclosed between a bread portion, wherein the bread portion comprises one of at least two slices of bread; a sliced hamburger bun with a bottom part and a top part; or a sliced hamburger bun and a middle slice of bread, wherein said wrapped salad portion comprises an edible wrapper enclosing one or more salad ingredients and optionally a salad dressing, and wherein the meat or protein portion can optionally comprise one or more salad ingredients that are outside the wrapped salad portion. The present invention involves the self-contained salad portion to be placed in a sandwich product, especially a fast food sandwich product, called hereinafter as a “combination sandwich,” wherein the self-contained salad portion is called a “wrapped salad portion”, wherein the wrapped salad portion comprises an edible wrapper that forms a closed pocket-like envelope holding a heap of salad ingredients and optional garnishes, and optionally a salad dressing, and wherein the envelope filled with salad ingredients has the form of a relatively squat flattened mass having an approximately square form or an approximately round form, in the shape of a substantially thick square or similar to a round hamburger patty. By “squat” it is meant that the depth or thickness is fairly small compared to the other dimensions. The squat form of the wrapped salad portion or insert is particularly useful when used in a sandwich product.

The present invention also involves a wrapped salad insert or wrapped salad portion to be placed in a sandwich, especially fast-food sandwich to improve the diet of the consumer, wherein the wrapped salad insert comprises an edible wrapper that forms a closed pocket-like envelope holding a heap of salad ingredients and optional garnishes, and optionally a salad dressing, and wherein the envelope filled with salad ingredients has the form of a relatively squat flattened mass having an approximately square form or an approximately round form, in the shape of a substantially thick square or similar to a round hamburger patty.

The present invention also involves a wrapped sandwich product to improve the diet of the consumer, comprising an edible wrapper that forms a closed pocket-like envelope holding one or more salad ingredients, a meat or protein portion, optional garnishes and optionally a salad dressing, and an optional bread portion. The wrapped sandwich product has the form of a relatively squat flattened mass having an approximately a square form or an approximation of a round form, in the shape of a substantially thick square or similar to a round hamburger patty.

The bread portion and the meat or protein portion of the sandwich product of the present invention comprise components of typical commercial sandwiches that are sold in fast food restaurants, said commercial “fast food sandwich” typically comprises a meat or protein portion that is placed inside a bread portion comprising a sliced bread roll or hamburger bun. The commercial fast food sandwiches are commonly named based on their meat content, for example, a chicken sandwich commonly comprises a piece of fried chicken between two pieces of a sliced hamburger bun; a fish sandwich comprises a piece of fried fish; and a roast beef sandwich comprises a heap of sliced roast beef. Fast food sandwiches that comprise one or more cooked patties of ground beef are normally called hamburger. Fast food sandwiches that comprise one or more meat patties and one or more slices of cheese are called cheeseburgers. Thus, the meat or protein portion can be one or more of: a cooked meat patty, a beef hamburger patty, a veal burger patty, a venison burger patty, a bison burger patty, a chicken patty, a turkey patty, a fish patty, sliced roast beef, sliced turkey, sliced chicken, sliced ham, sliced bologna, textured vegetable (soy) protein patty, sliced cheese, patty-shaped cooked egg, and mixtures thereof.

The bun and/or sliced bread provide the basic strength of a support structure while the wrapper provides the containment for the desired salad ingredients, including not only healthy salad ingredients, but also finely divided salad ingredients and garnishes with desirable taste and/or mouth feel properties. This approach allows one to create a fast food sandwich product that the consumer feels comfortable with eating and which can include popular meat or protein portions such as hamburger patties, while also offering the salad portion including an edible wrapper with salad ingredients including leafy vegetable such as lettuce and/or spinach, and other finely divided salad ingredient mixtures and optionally a salad dressing that stay contained and separated from the remainder of the sandwich while the product is being eaten.

Since the wrapped salad portion is eaten with the bread and meat, the combination provides a complex taste palate for the consumer while filling the stomach with healthy ingredients and relatively minimizing calorie intake, and at the same time providing a much more convenient way to consume the salad portion in combination with a traditional sandwich, instead of having to eat a sandwich and a salad separately, which requires additional utensils for the separate salad.

### Ingredients

### The Bread Portion

The combination sandwich of the present invention comprises a bread portion comprising at least two slices of bread; a two-part hamburger bun of a sliced hamburger bun; or a three-part hamburger bun comprising a sliced hamburger bun and a middle slice of bread, which is similar to the bread portion of a Big Mac sandwich. A single slice or portion of bread can be used with a wrapped salad insert or portion placed on top, in the form of the well-known “open faced” sandwich. A two-part hamburger bun or a sliced hamburger bun commonly comprises a flat bottom part and a dome-shaped top part. The term “sandwich” is used herein to indicate any assembled multi-component food product such as a sandwich, a burger and the like, in which a bread outer food component comprises two or more separate slices of bread to enclose or contain an inner food component, where the inner food component can include a food used as a topping. The term “bread portion” is used herein to indicate any farinaceous food component of a approximation of a square to a round form, preferably a round form, and specifically refers to bread components that do not completely enclose the inner food component, such as sliced hamburger bun, sliced Kaiser roll, sliced bread, sliced bagel, and sliced croissant, preferably sliced hamburger bun and sliced Kaiser roll.

The bread components herein can comprise other bread-like components, but especially include sliced hamburger buns, sliced Kaiser rolls, and sliced bread, preferably sliced hamburger buns and sliced Kaiser rolls.

It will be appreciated that other ingredients may be added to adjust the flavor or improve the functionality of the bread component or portion. Examples of ingredients that can be added to adjust the flavor of the bread can include butter, cheese, meat, natural flavors or spices, fruits, nuts, and the like. The bread component can also be topped with a seed topping such as poppy seeds, sesame seeds, or salt grains.

Different bread types are suited for different types of sandwiches including: white, wheat, whole grain, multigrain, focaccia, rye, pumpernickel, and sliced French bread.

The sandwiches are typically two-sided, e.g., they have two separate pieces of bread with the other sandwich materials placed between the pieces of bread. They can also be double-decker and triple-decker sandwiches with multiple layers of ingredients between the pieces of bread. The preferred combination sandwich of the present invention comprises two halves of a sliced hamburger bun, without a third slice of bread, to reduce the bulkiness of the combination sandwich. A convenient way to combine the wrapped salad portion with the rest of the ingredients of the combination sandwich is simply to place the wrapped salad portion on top of the meat or protein portion, namely, between the meat or protein portion and the top half of the bread portion, such as the top half of a hamburger bun.

### The Meat or Protein Portion

Non-limiting examples of materials that can be used as the meat or protein portion include different meat patties, such as beef hamburger patties, veal burger patties, chicken patties, turkey patties, fish patties, or sliced meat such as roast beef, chicken, turkey, ham, salami, bologna, and various sliced cheeses such as cheddar cheese, American cheese, Swiss cheese. Animal game meat such as venison or bison meat can also be used. Other suitable meat or protein portion can comprise, such as, textured vegetable (such as soy) protein patties or patty-shaped egg. Such veggie burgers and veggie chicken patties are commercially available from, such as, MorningStar Farms® Company. Common materials used as meat or protein portion in fast food sandwiches typically include cooked meat patty, beef hamburger patty, chicken patty, turkey patty, fish patty, sliced roast beef, sliced turkey, sliced chicken, sliced ham, sliced bologna, textured vegetable protein patty, sliced cheese, patty-shaped cooked egg, and mixtures thereof. The invention is especially desirable for hamburger sandwiches which are very popular with young people who do not normally eat healthful meals. Such sandwiches normally contain only a small amount of salad ingredients such as a small amount of lettuce, tomato, sliced onion, and pickle. The meat or protein portion can optionally comprise one or more salad ingredients that are outside the wrapped salad portion.

### Self-Contained, Wrapped Salad Portion

The present invention comprises a self-contained, spill-free or spill-resistant, wrapped salad portion comprising an edible wrapper that forms a closed pocket-like envelope holding a heap of salad ingredients and optional garnishes, and wherein the pocket filled with salad ingredients and garnishes has the form of a relatively squat flattened mass having an approximately square form or an approximation of a round form, in the shape of a substantially thick square or round hamburger patty, of thickness of at least about 1 centimeter, about 2 cm, about 3 cm, about 4 cm, about 5 cm, about 6 cm, or about 8 cm, and of average diameter of at least about 7 cm, about 9 cm, about 11 cm, about 13 cm, or about 15 cm, depending on the size of the bread portion. Spill-free, or spill-resistant or self-contained means that the intact combination sandwich can contain the salad ingredients, including finely divided salad ingredients and optional garnishes, and optionally a salad dressing, without having the ingredients spill out of the sandwich in the way that such ingredients, garnishes and dressing spill out of a conventional sandwich. The self-contained, spill-free salad portion of the present invention has a weight of at least about 40 g, about 60 g, about 80 g, about 100 g, about 120 g, about 140 g, or about 160 g.

### The Salad Ingredients

The present invention provides for the introduction of a substantial amount of salad ingredients into a sandwich. Examples of salad ingredients include leafy salad ingredients, such as chopped lettuce or cut up lettuce, shredded lettuce, fresh spinach leaves, fresh baby spinach leaves, chopped fresh spinach, edible dandelions, shredded green cabbage, shredded red cabbage, shredded savoy cabbage, as well as other savory salad ingredients and garnishes. By chopped lettuce, it is meant lettuce leaves that are cut up or broken into pieces of sizes from about 1 cm to about 6 cm in size. Other salad ingredients such as onion and bell pepper can also be chopped with a knife, but into smaller pieces, such as approximate cubes of sizes of about 1.5 cm or less, or slivers of length about 5 cm or less and thickness of about 1 cm or less, and even smaller sizes for harder ingredients, such as chopped pistachios. Lettuce can include iceberg lettuce, green romaine lettuce, red romaine lettuce, green leaf lettuce, red leaf lettuce, Boston lettuce, and the like, and young leaf lettuce, such as, baby red romaine lettuce, baby green romaine lettuce, baby spinach, baby red swiss chard, red chard, mache lettuce, red mustard, baby red oak, baby green oak, parella, lolla rosa, tango, totsoi, arugula, mizuma, radicchio, and frisee. A popular leafy mixture that can be added to the salad portion is commonly known as “spring mix,” comprising one or more of baby red romaine, baby green romaine, baby red leaf, baby green leaf, baby red Swiss chard, baby red oak, baby green oak, parella, lolla rosa, tango, tot soi, arugula, mizuma, radicchio, or frisee. To reduce the bulkiness of the wrapped salad portion and to maximize the amount of the salad ingredients in the wrapped salad portion, it is preferred to use flatter and/or soft lettuce leaves and/or spring mix leaves to prepare the salad ingredients, instead of the studier, bulkier, and/or harder leaves. For example, the outer leaves of an iceberg lettuce (without the stem part) are more preferred than the inner leaves which are studier and have more bulky folds; green leaf lettuce is more preferred than romaine lettuce; and the flat baby spinach is more preferred than the hard and bulky radicchio. However, the harder and bulkier pieces are still suitable for use in the wrapped salad portion. Examples of other savory salad ingredients and garnishes include shredded carrots, thin-sliced carrots, cut-up celery, sliced cucumber, sliced onion, slivered onion, chopped onion, chopped green onion (or chopped scallions), sliced radishes, shredded radishes, cilantro, chopped cilantro, mints, chopped mints, basil, chopped basil, sliced pickles, coleslaw, sliced, slivered, or cubed bell pepper. including green bell pepper, red bell pepper, yellow bell pepper, and/or orange bell pepper, red pepper, sliced jalapeño, sliced black olives, small pepper-stuffed green olives, sliced or chopped mushrooms, chopped boiled egg, chopped tomatoes, red cherry tomatoes, yellow cherry tomatoes, grape tomatoes, cut up sun-dried tomatoes, sliced roasted tomatoes, garlic, roasted garlic, seedless grapes, raisins, sliced dried cranberries, sliced dried cherries, sliced dried apricots, maraschino cherries, chopped pineapple, grated cheese, grated parmesan cheese, shredded cheddar cheese, shredded mozzarella cheese, blue cheese crumbs, green peas, garbanzo beans or chick-peas, boiled corn kernels, sunflower kernels, chopped pistachios, sliced toasted almonds, pecan, walnuts, pumpkin seeds, red beet slices, bean sprouts, broccoli pieces, cauliflower pieces, cut up asparagus, bacon bits, chopped sausage, chopped bologna, chopped ham, chopped chicken, croutons, and the like. Mixtures of any and all of the above that meet the taste desires of the consumer can be used. Cheese in slices, such as sliced cheddar cheese and sliced Swiss cheese, are normally served melted along with the meat, and are not typically part of the leak-free salad portion. Uncommon ingredients such as cooked rice noodles, whole large cooked shrimps, dried shrimp, oysters, sliced boiled pork belly (with fat and skin on), and kimchi are not preferred because they unnecessarily add extra caloric content, off taste, and/or chewy properties. However, some fried bacon and bacon bits can be used in the present invention to enhance the flavor of the salad ingredient mixtures.

### Garnishes and Dressings

Garnishes and salad dressing can be used along with the salad portion of the present invention. Garnishes can include, though not be limited to, butter, mayonnaise, mustard, ketchup or catsup, olive oil, cream, cheese, and chutney. Salad dressing can include a thick sauce or creamy sauce form, or a runny, low viscosity liquid. The main ingredients of salad dressings are typically oil, vinegar, water, garlic, onion, sugar or high fructose corn syrup, salt, spices, and sometimes thickener, such as xanthan gum and/or natural or artificial color. Other ingredients are added to create salad dressings of different flavors. For example, balsamic vinaigrette salad dressing contains balsamic vinegar. Italian salad dressing typically contains some red bell pepper. French salad dressing contains tomato puree and paprika. Ranch salad dressing contains some egg yolk and parmesan cheese. Thousand Island salad dressing contains egg yolk, tomato puree or tomato paste, red bell pepper and mustard. Asian salad dressing and sweet and sour salad dressings are typically sweet and contain sugar or high fructose corn syrup. Caesar salad dressing contains parmesan and/or romano cheese, lemon juice, and anchovies. Blue cheese salad dressing typically contains blue cheese, egg yolk, mustard seed, and sometimes buttermilk. Honey mustard salad dressing contains honey, mustard seed or Dijon mustard, and egg yolk. Southwestern salad dressing contains ranch dressing with barbecue sauce or horseradish sauce, and cilantro. A thick or creamy salad dressing can be used in a wrapped salad portion with a rice paper wrapper, while thinner, less viscous salad dressing can be used in a wrapped salad portion with a lettuce wrapper or in a salad portion comprising an outer rice paper wrapper and an inner lettuce layer.

### The Edible Salad Wrappers

An important component of the present invention is a thin, low calorie edible wrapper element in an approximately square or approximately round form. There has been a long standing need for healthier sandwich products. The current elegant solution is only possible with a thin, low-calorie edible wrapper, which clearly no one has previously thought of or thought possible. Applicants have found two approaches. The first is to use rice paper, which is a processed edible wrapper. Although rice paper has carbohydrates, there are very few calories in rice paper and when moistened, it is softened and can be folded around salad ingredients to make a convenient wrapped salad portion in the form of a thick patty to suitably insert and fit into a traditional sandwich product. Since rice paper has been used for a very long time to make elongated cylindrical spring rolls and egg rolls, it is quite surprising even with the great, urgent need for providing a nutritionally balanced sandwich product and the intense competition in the fast-food hamburger sandwich restaurant business, rice paper was never considered nor appreciated for wrapping a salad ingredient mixture in a suitable form for inserting in a sandwich. Another suitable processed edible wrapper is soy paper (or soybean paper or mamenori).

The second approach is to use fresh, steamed or wilted leaves such as lettuce or cabbage leaves, which are natural edible wrappers. Again, it is surprising, considering the need, that no one has ever contemplated such a wrapper and the salad ingredient mixture that is wrapped completely inside to facilitate its addition to a normal sandwich.

Thus, the present invention comprises edible wrappers with thin structures like softened or hydrated rice paper, leafy wrappers like whole lettuce leaves, cabbage leaves, etc. either fresh or wilted or blanched to improve folding properties, and combinations thereof. For the combination sandwich of the present invention, softened or hydrated rice paper and iceberg lettuce leaves are the most preferred for use in the combination sandwich of the present invention. Softened rice paper, iceberg lettuce leaves, blanched iceberg lettuce leaves, and combinations thereof, are preferred for use as wrapper for the salad portion of the present invention since they can be readily manipulated into the desired shapes. Such materials control the salad ingredient contents while not adding appreciably to the caloric content of the sandwich product. Wrappers that are suitable for use to prepare the self-contained salad portion of the present invention are either flat or concave, and have an approximate round shape, with an average diameter of at least about 20 cm, preferably from about 22 cm to about 32 cm, more preferably about 24 cm to about 26 cm. For concave wrappers, the diameter is measured along the curvature of the concave surface. A wrapper with the shape in approximation of an oval or elliptic form is suitable for use to prepare a wrapped salad portion when the minor diameter along the minor axis is preferably at least about 19 cm. A wrapper with an approximate square form is suitable for use to prepare a self-contained salad portion when the side of the square is preferably at least about 19 cm.

When a processed wrapper is used, it is important that the wrapper is thin and resilient to reduce its contribution to the volume and thickness of the wrapped salad portion. The processed wrappers are wrappers made from flours, such as rice papers. The wrapped salad portion should comprise mainly salad ingredients, and the amount of wrapper should be minimal to reduce the bulkiness of the wrapped salad portion.

In a first aspect of the invention, where the vegetable or salad ingredients are wrapped and combined with a separate meat or protein portion on a bread portion, the thickness of a processed wrapper should be less than about 0.9 mm, less than about 0.8 mm, less than about 0.7 mm, less than about 0.6 mm, less than 0.5 mm. Commercially available edible rice papers (banh trang) are made of rice flour, tapioca flour, or rice flour mixed with tapioca flour, with salt and water. Rice papers are normally available in the form of dry and thin round or square sheets, with diameter (or side) of from about 15 cm to about 32 cm. Dry rice papers that are suitable for use as salad wrappers of the present invention typically have thickness of from about 0.20 mm to about 0.70 mm, preferably from about 0.25 mm to about 0.65 mm. Rice papers that have a thickness of about 1.0 mm, or larger, are not preferred. Dry rice papers that are suitable for use as salad wrappers of the present invention typically have a weight of from about 1.8 g/100 cm² to about 3.2 g/100 cm², preferably from about 2.0 g/100 cm² to about 3.0 g/100 cm². This is to compare with another type of processed wrapper, namely the very well known wheat-based and corn-based tortilla sheets, that typically has a thickness greater than 1 mm, for example, 1.2 mm or more, and a weight typically from about 10 g/100 cm² to about 15 g/100 cm²; tortillas are not suitable for use in the combination sandwich of the present invention because they unnecessarily add extra caloric content and bulkiness to the sandwich product. Rice papers that are particularly suitable for use as salad ingredient wrappers of the present invention are round sheets having a diameter of from about 23 cm to about 32 cm. Dry rice papers are very brittle. The brittle dry sheets of rice paper are dipped briefly in warm water to be hydrated and softened, then used to prepare the wrapped salad portion. It takes about one minute for the moistened rice paper to be suitably softened for use as a wrapper of the salad portion of the present invention. A dry rice paper commonly picks up about 40% to 60% its weight of water when it is moistened and becomes softened. Softened rice papers have a thickness of about the same or slightly thicker than the dry rice papers before they are hydrated. The rice papers that are freshly prepared from rice and tapioca flours are commonly placed on bamboo trays for drying. When dried, the rice papers receive raised impressions from the bamboo tray surface which make the rice paper surface uneven and bulky, and thus make the thickness of the dry rice papers larger than if they are totally flat. When a piece of rice paper is moistened and softened, the raised impressions are somewhat smoothened out, which makes the thickness of the softened rice paper somewhat comparable to the dry rice paper. The softened rice paper is resilient, somewhat stretchable, and fairly sticky that helps the salad portion held together well. The softened rice paper is also translucent, and thus allows the salad ingredients to be partially visible to increase their taste appeal.

Another edible processed wrapper that is suitable for used as wrapper for the wrapped salad portion of the present invention is soy paper that is made from soybean. Also called soybean paper or mamenori, soy paper is flexible and thin, and is currently used to replace seaweed (nori) in some sushi.

In a second aspect of the invention, where the salad ingredients and the meat or protein portion are both wrapped together, the rice papers can have a thickness of about 0.4 mm to about (up to about) 0.9 mm, or more, and more typically about 0.5 mm to about 0.9 mm. When a wrapper having better strength is necessary, such as in the case of a wrapped sandwich product which is consumed without sandwich buns, two layers of softened rice paper can be used to prepare the wrapped product.

Many processed wrapper materials have been used by themselves to make rolled products. That is, they are typically wrapped in elongated tube form for the ease of dipping them into different sauces, minimizing the amount of the incorporated materials that are exposed at one time, and the ease for consumption, one bite at a time from a long roll. For sandwiches, a flat folding structure in approximately square or approximately round shape fills the sandwich and provides room in the wrap for sufficient salad ingredients without excessively increasing the thickness of the sandwich. Non-directional folded shapes that maintain control over the contents despite the selection of any point of “attack” (starting point for biting into the sandwich) are desirable. Corn-based and wheat-based tortilla wrappers may not be suitable if they are too thick and bulky for use in a sandwich and unnecessarily add extra caloric content. Other wheat-based food wrappers such as wheat-based pancakes and leavened wheat-flour flatbread, such as pita bread, lavash bread, and naan bread, wheat-based dumpling skins, wonton skins, gyoza skins, crêpe, and lumpia and lumpiang sariwa wrappers are also too thick and bulky, or need to be cooked, and are not suitable. Nori or seaweed wrapper, used in the preparation of sushi, is another processed wrapper that is not suitable for use as wrapper for the preparation of the wrapped salad portion of the present invention because it is very brittle when dry and disintegrates when moistened, and impacts a fishy taste that is not familiar with many consumers.

The second type of edible wrappers that are suitable for use in the present invention are natural edible wrapper comprising broad leafy wrappers such as lettuce leaves and cabbage leaves. The lettuces that are suitable for use as natural wrappers in the combination sandwich of the present invention are those that have broad, even, and flexible leaves, such as iceberg lettuce, red leaf lettuce, and green leaf lettuce. Romaine lettuce leaves are too strong and springy, and have too broad and strong stems for use as a wrapper, so romaine lettuce leaves are less preferred. Iceberg lettuce is especially preferred.

Lettuce leaves are preferred as salad wrappers because they serve both as wrappers and as the main ingredient of the salad portion. Therefore, the weight of the lettuce leaves is not of a concern, unlike the weight of the processed wrappers which needs to be minimized to reduce their unnecessary caloric contribution to the combination sandwich product, as has been discussed herein above. Iceberg lettuce leave is most preferred among the lettuces for use as wrapper. Iceberg lettuce leaves are more suitable because they are large, broad, and even, and have a relatively small stem and a concave shape that is suitable to be used as a wrapper. However, the iceberg lettuce leaves are still springy, and sometimes retain some wavy structure, especially the inner leaves, that can make the wrapper bulky, not compact, and a salad portion made with an iceberg lettuce leaf needs to be held in place for containment of the salad ingredients by the hamburger bun slices. To render a piece of iceberg lettuce leaf more malleable and resilient to form a pocket, having less of a tendency to tear, and having edges that can stick together more, it is desirable in an alternative embodiment to blanch a lettuce leaf in boiling water or in a steamer, or most conveniently by microwaving a leaf, preferably wet leaf, for about 30 seconds or less. The thus blanched leaf becomes more resilient, having a less tendency to break, smoother and less wavy, and can be folded around the salad ingredients and keep the shape of the salad portion well, while it is still crunchy to the bite.

A suitable method for removing the iceberg lettuce leaves one at a time is to cut the stem that connects the outermost leaf to the central stem and carefully loosen and remove said leaf from the lettuce head, then cut the stem that connects the next leaf to the central core and loosen and remove said leaf, and the process is continued one leaf at a time for the inner leaves. The outer leaves can be softened somewhat to facilitate the removal of the leaves by heating the whole head of lettuce in a microwave oven (such as a microwave oven with power of about 1,000-1,100 watts) in full power for a short period of time, e.g., less than about a minute, even as much as from about 30 seconds to about 1 minute. After one or more leaves are removed, the remaining lettuce head is heated by the microwave oven again to repeat the process. A most preferred method for loosening and safely removing the iceberg lettuce leaves from a lettuce head without being torn or otherwise broken or damaged is to start by first coring the central stem using either a sharp pointed and thin-bladed serrated (steak) knife or a powered long drill bit, or other sharp bladed devices, to cut a cone shaped portion of the central stem to release the leaves. The removed central stem has the form of a cone. The central stem holds the lettuce leaves together by connecting with the end of each individual stem of each leaves. The whole head of lettuce without the central stem is then heated in a microwave oven (such as a microwave oven with power of about 1,000-1,100 watts) in full power for a short period of time, e.g., less than about a minute, even as much as from about 30 seconds to about 1 minute. The outside leaves become warm and somewhat softened and more resilient, but not wilted, and still crunchy to the bite. If the leaves become wilted, the time is adjusted to be shorter. The outer leaves are then loosened and removed one by one for use in forming wraps. After removing about two or three leaves, the lettuce head can be warmed again for about 30 seconds to 1 minute so that the next layers of leaves can be released easily.

The typical iceberg lettuce leaves that are suitable for use as the wrapper have a weight of from about 27 g or heavier, preferably from about 32 g to about 55 g, more preferably from about 35 g to about 50 g. An iceberg lettuce head can be used in its entirety in the combination sandwich of the present invention. The outermost leaves are carefully separated to avoid tearing for use as wrapper. The innermost leaves are sliced up, shredded up, etc., to make the lettuce salad ingredient of the salad composition, although the flatter, less wrinkled outer leaves are also suitable and/or preferred when cut up for creating the salad portion.

Cabbage leafs have the sizes and shapes that are very suitable to be used as a wrapper for a salad portion of the present invention. However, they are too stiff and springy, and very chewy when fresh and raw. Their stem is also very broad and strong, and thus prevents them from being folded easily for a good wrapper. The raised part of the stem is preferably trimmed off to make the leaf more malleable. Cooked cabbage leaves, such as by boiling or steaming for several minutes make them noticeably more malleable and thus more suitable for use as a wrapper for the present invention. Microwaving cabbage leaves does not easily wilt them because they have low water content. Cabbage leaves are more easily wilted if they are sprayed with a cooking spray, such as PAM® cooking spray, on one or both sides of the leaves before microwaving to improve absorption of the microwave heating energy. This treatment makes the cabbage leaves amenable to be cooked and become malleable to be very suitable for use as a wrapper for this invention. Savoy cabbage is more preferred because it has a smaller stem. Like iceberg lettuce, while the outermost cabbage leaves can be used as wrapper, the inner leaves can be used to prepare coleslaw as a savory salad ingredient. Oriental cabbage such as napa cabbage and celery cabbage have leaves with long oval shape and very large and thick stem, and are not suitable for use as a wrapper for the salad portion of the present invention.

Lettuce leaves, green cabbage leaves, and savoy cabbage leaves are thin, except for the stems. However, the whole leaves, including the stems, are counted as salad ingredients, and lettuce leaves, green cabbage leaves, and savoy cabbage leaves are suitable for use as wrappers in the present invention.

Rice paper and lettuces have been used by themselves to make rolled foods, that is, they are typically wrapped in elongated tube form for the ease of dipping them into different sauces, minimizing the amount of the incorporated materials that are exposed at one time, and the ease for consumption, one bite at a time from a long roll. For sandwich products, a squat, flat folding structure in approximately square or approximately round shape is essential to fill the sandwich and provide room in the wrap for sufficient salad ingredients without excessively increasing the thickness of the sandwich. Non-directional folded shapes that maintain control over the contents despite the selection of any point of attack are desirable.

In a preferred embodiment, a rice paper and a lettuce leaf are used together to form a wrap containment for a salad ingredient mixture, wherein a rice paper is used as the main outer layer and a smaller trimmed lettuce leaf forms an inner layer. This arrangement allows the addition of a copious amount of salad dressing, especially a thin, low viscosity salad dressing directly to the salad ingredient mixture, without the risk of the salad dressing over-softens the rice paper and causes a leak of the salad dressing through the rice paper layer.

### Preparation of Wrapped Salad Portion

In one embodiment, the preparation of a wrapped salad portion for use in the combination sandwich comprises the steps of (1) placing a wrapper on the flat or concave surface, such as a flat or concave plate, also referred to herein as a template; (2) selecting and placing the salad ingredients into a heap in the middle portion of the wrapper; (3) optionally adding a salad dressing; (4) raising an edge of the wrapper and wrapping or folding the edge somewhat tightly over the salad ingredient mixture, followed by consecutively raising and folding the nearby or adjacent edges to fully enclose the salad ingredient mixture. The amount of salad mixture is such to allow each edge of the wrapper to overlap the opposite edge of at least about 2 cm to obtain a stable adhesion between the over-lapped edges and a spillage free containment. Typically a wrapper can be folded four times using the four (two pairs of) opposed edges to form a somewhat flat square wrapped salad portion. More preferably, the wrapper can be folded five or more times to obtain an approximate flat rounded salad portion.

When rice paper is used as the wrapper, the moistened rice paper wrapper is somewhat sticky, and the folding of the edges of the wrapper make the overlapping edges stick together and hold the rounded salad portion in shape. The moistened rice paper wrapper remains moist, soft, and resilient for some time, and the salad portion can be readily consumed. However, when the rice paper-covered salad portion is exposed in open air without protection, the rice paper can dry up and firm up, making the salad portion more study to chew and less palatable. Therefore, when wrapped salad portions are made in advance for use several hours later, they should be wrapped in plastic wraps or placed in a cold-temperature humidifier.

An alternative embodiment for preparing salad portions with rice paper for later use is to moisten the rice paper wrapper with an aqueous solution of a food humectant, such as glycerol, propylene glycol, sorbitol, and mixtures thereof, to keep the rice paper moistened longer. Said aqueous solution can have a mass concentration of from about 0.1% to about 5%, more preferably from about 0.2% to about 2% of humectant in water. A wrapped salad portion made with a moistened rice paper using an aqueous food humectant solution can remain moist and soft for a longer time.

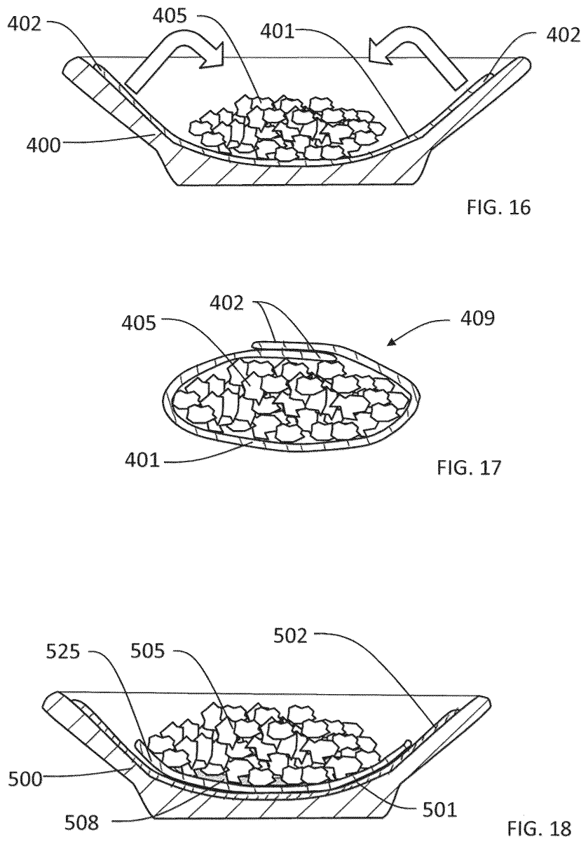

FIGS. 15-17 show the elements needed to prepare a wrapped salad portion with one large, softened round rice paper, comprising a concave template 400 holding relative larger softened round rice paper 401 having edges 402, said rice paper 401 holding a heap of salad ingredient mixture 405 in its middle. Cross-sectional view FIG. 16 shows that the extending edges 402 of the rice paper that are to be folded inwardly, over the heap of salad ingredient mixture 405, and sealed together. FIG. 17 shows the wrapped salad portion 409 removed from the template 400. A wrapped salad portion 409 with one large leaf of iceberg lettuce can be prepared similarly, with the softened round rice paper being replaced by a concave round lettuce leaf.

In preparing the wrapped salad portions with a lettuce wrapper, the common single-use, one-size-fit-all, clear, thin high-density polyethylene disposable gloves can be used. However, in the preparation of wrapped salad portions with softened rice paper wrappers, these thin and extra sized high-density polyethylene gloves are too flimsy and have floppy flanges that tend to stick to the sticky softened rice paper wrappers. It is found that a food-safe nitrile glove 900, illustrated in FIG. 23, fits the hand better and does not stick to the softened rice papers and thus provides better dexterity for handling softened rice paper wrappers. Food-safe nitrile gloves are preferred to prepare wrapped salad portions that comprise softened rice papers.

In an alternative embodiment, the folding of the edges of the wrapper starts with folding and overlapping two opposed edges, followed by the folding and overlapping of the two remaining two opposed edges. For an iceberg lettuce wrapper, it is easiest and preferred to fold the two opposed side edges first, followed by folding the edge containing the main stem and its opposed tip edge, with the opposed tip edge overlapping over the stem edge. The resulting wrapped salad portion can take the form of an irregular square patty that can be slightly elongated approaching a rectangular patty, which is still suitable for use in the sandwich product of the present invention.

The flat or concave preparation surface or template can be any smooth surface such as a flat or concave earthenware or ceramic plate, stainless steel, or smooth wooden surface. For the sticky softened rice paper wrapper, it may be helpful to use a non-stick surface, such as a surface coated with Teflon, Analon, Calphalon, Circulon, silicone, and the like. By “concave” it is meant a surface which is curving in or hollowed inward.

When the wrapper of the wrapped salad portion is a softened rice paper that is somewhat sticky, the edges of the rice paper wrapper can stick together well enough to independently provide spill-free or spill-resistant containment. The edges of some boiled or steam lettuce leaves and cabbage leaves can similarly hold together by themselves to form spill-free wrapped salad portion.

When the wrapper is a fresh or undercooked lettuce leaf or a cabbage leaf, which does not possess stickiness, some gloved fingers of a preparer or some weight of a mechanical folder may need to press slightly the edges in place while transferring the wrapped salad portion from the preparation surface or template to the top of the meat or protein portion layer, and capped with the top part of the hamburger bun, before the wrapped salad portion becomes spill-free.

In an alternative embodiment, the edges of a fresh lettuce leaf wrapper of a wrapped salad portion can be held together by a sticker made with a piece of an edible processed wrapper that is coated on one side with an edible aqueous binder fluid or paste. The coated side of the edible wrapper is applied to the top of the wrapped salad portion to hold the exposed lettuce leaf wrapper edges in place. The sticker can be made of any flexible edible thin sheet, preferably it is made of a thin wrapper material of less than about 1 mm in thickness, preferably selected from softened rice paper or soy paper, preferably softened rice paper. The sticker is preferably made with a piece of rice paper wrapper, such as a quarter of a 25-cm-diameter round rice paper wrapper, more preferably the rice paper sticker is of approximately round form of about 6 cm to about 12 cm in diameter. The edible aqueous binder fluid or paste contain a gum powder, such as xanthan gum powder, guar gum powder, and mixtures thereof, said fluid and paste containing from about 0.2% to about 20%, preferably from about 0.3% to about 10% of solid in water. The preferred powders are xanthan gum powder, guar gum powder, acacia gum powder, and mixtures thereof. Non-limiting examples of suitable binder fluids and pastes that are suitable for use keep a fresh iceberg lettuce wrapper closed include a 0.5% guar gum fluid, or a 1% xanthan gum fluid. Suitable edible adhesives are also commercially available, such as Wilton Dab-N-Hold™ edible adhesive.

FIG. 20 shows a cross-sectional view along a vertical plane of a wrapped salad portion 602 comprising a lettuce leaf 625 as an edible natural wrapper enclosing a quantity of salad ingredient mixture 605 being placed upon the lettuce leaf 625. The edges 627 of the lettuce leaf 625 are overlaid to contain the salad ingredient mixture, and a softened piece of rice paper 610 is placed over the overlapped edges 627 of the lettuce wrapper as patch or sticker 610. An edible adhesive material 612 can be applied to the inside of the rice paper patch 610 to assist in adhering the patch 610 to the edges 627 of the lettuce wrapper 625 to prevent the edges 627 from loosening and disengaging from one another, and to keep the lettuce wrapper remaining in a closed form as a container for the salad ingredient mixture.

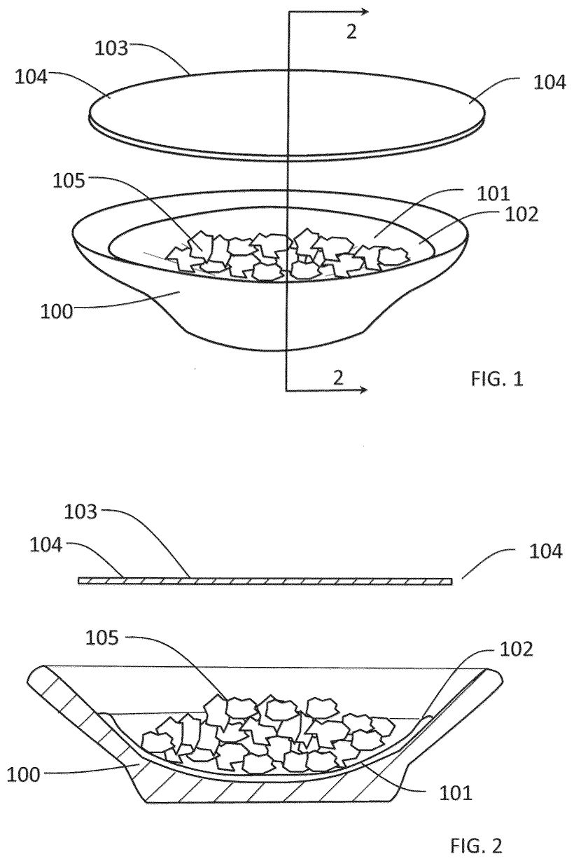

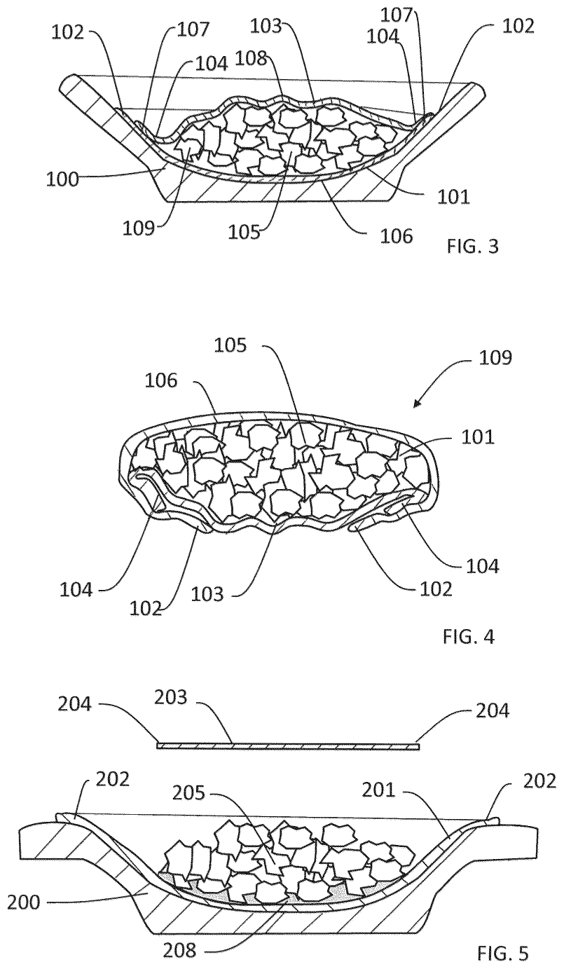

Another embodiment of the invention is a method to prepare a rice paper wrapped salad portion (or a wrapped sandwich product) using two pre-softened approximately round rice papers of slightly different dimensions, as illustrated in FIGS. 1 to 4, comprising the steps of (1) placing the first and slightly larger softened round rice paper in a concave template; (2) selecting and placing the salad ingredient mixture at the middle of the first softened round rice paper (FIGS. 1 and 2); (3) laying the second and slightly smaller softened round rice paper on top of the salad ingredient mixture, which optionally includes a salad dressing, in a manner that the edges of the second round rice paper touch the edges of the first round rice paper, and the edges are pressed together snuggly in such a way that the first round rice paper and the second round rice paper stick together to form a circular pouch that tightly encloses the salad ingredient mixture in the middle and a flat outer rim or flange made with two layers of rice paper (FIG. 3); and (4) the outer rim is folded back to stick on the second round rice paper to form the round wrapped salad portion patty (FIG. 4).

FIG. 1 shows an exploded perspective view of the elements needed to prepare a wrapped salad portion with two softened round rice papers comprising a concave template 100 holding the first and slightly larger softened round rice paper 101 having edges 102, said first rice paper 101 holds a heap of salad ingredient mixture 105 in its middle, and the second softened round rice paper 103 still being separated, with edges 104, wherein the second rice paper 103 can be slightly smaller in diameter than the first rice paper 101.

FIG. 2 shows a cross-sectional view along a vertical plane of the elements of FIG. 1, taken along line 2-2 of FIG. 1, and showing the concave template 100; the first softened round rice paper 101 with edges 102, and with the first rice paper 101 fitting snuggly within the concave template 100 and holding the salad ingredient mixture 105; and the separate second softened round rice paper 103 with edge 104.

FIG. 3 shows the cross-sectional view of FIG. 2, with the second softened round rice paper 103 now being laid on top of the salad ingredient mixture 105 in a manner that the edges 104 of the second round rice paper 103 touch the edges 102 of the first round rice paper and the edges are pressed together snuggly in such a way that the first round rice paper and the second round rice paper stick together to form the circular or rounded pouch 106 to tightly enclose the salad ingredient mixture 105 in the middle and a flat outer rim or flange 107 made with two layers of rice paper. The outer rim 107 will be folded back to stick on the outside face of 108 of the second round rice paper 103 to form the round wrapped salad portion patty 109 that is to be removed from template 100.

FIG. 4 shows a cross-sectional view of the separated round wrapped salad portion patty 109 comprising pouch 106 formed by the fusion of edges 102 of the first softened rice paper 101 with the edges 104 of the second softened rice paper 103 and enclosing the salad ingredient mixture 105.

A non-limiting, illustrative example for the preparation of a wrapped salad portion of the sandwich product by the method using two softened round rice papers of slightly different dimensions as depicted by FIGS. 1 to 4 comprises a first round rice paper of a diameter of about 19 cm and a second round rice paper of a diameter of about 16 cm to form an squat round enclosure to contain about 80 g of a salad ingredient mixture resulting in a round wrapped salad portion patty with a diameter of about 11 cm in diameter and a thickness of about 4.5 cm.

In this embodiment wherein the wrapped salad portion comprises two softened approximately round rice papers of slightly different dimensions, the larger approximately round rice paper has a diameter of from about 17 cm to about 23 cm, and the smaller round rice paper has a diameter of from about 14 cm to about 18 cm.

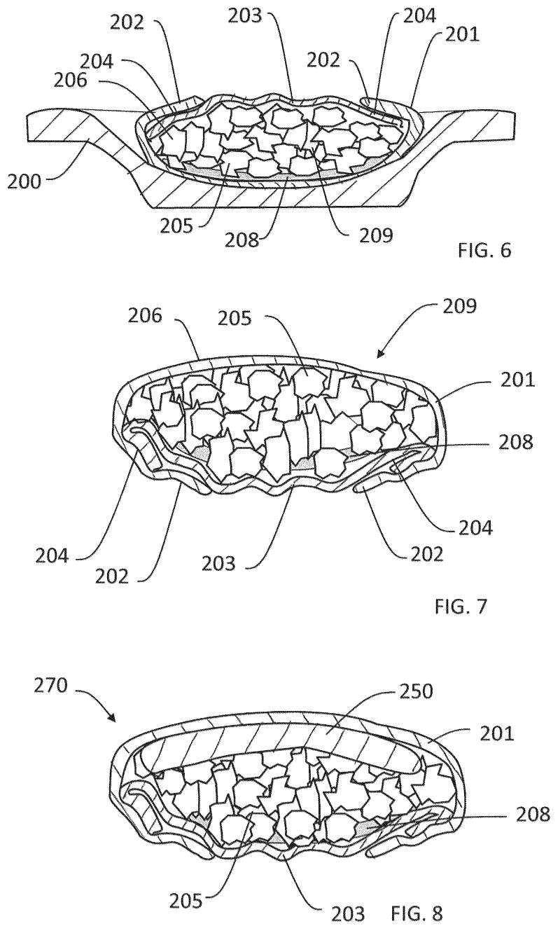

An alternative embodiment is a method to prepare a rice paper wrapped salad portion using two softened approximately round rice papers of significantly different dimensions, including a second round rice paper that is significantly smaller than the first round rice paper, as illustrated in FIGS. 5 to 7, comprising the steps of (1) placing the first and significantly larger softened round rice paper in a concave template; (2) selecting and placing the salad ingredient mixture optionally including a salad dressing at the middle of the first softened round rice paper (FIG. 5); (3) laying the second and significantly smaller softened round rice paper that is freshly moistened and is still fairly rigid on top of the salad ingredient mixture; (4) the edges of the first softened round rice paper are folded and pressed snuggly over the second rice paper to form a circular pouch to tightly enclose the salad mixture in the middle to form the round wrapped salad portion patty (FIG. 6); and (5) releasing the round wrapped salad portion patty from the template (FIG. 7). In this method, the diameter of the second rice paper has approximately similar diameter as the resulting wrapped salad portion patty, with the diameter of the first diameter about the roughly twice the diameter of the second rice paper. It is essential to prepare and finish step 1 and step 2, before the smaller second round rice paper is moistened and placed immediately on top of the salad ingredient mixture when the second rice paper is still fairly rigid, to be used as the guide to fold the edges of the first rice paper over.

FIG. 5 shows a cross-sectional view along a vertical plane of the elements needed to prepare a wrapped salad portion with two softened round rice papers of significantly different sizes, comprising a concave template 200 holding the first and larger softened round rice paper 201 having edges 202, said first rice paper 201 holds a heap of salad ingredient mixture 205 and a salad dressing 208 in its middle, and the second and smaller freshly softened round rice paper 203 still being separated, with edges 204, wherein the second rice paper 203 is smaller in diameter than the first rice paper 201.

FIG. 6 shows the cross-sectional view of FIG. 5, with the freshly softened second round rice paper 203 now being laid on top of the salad ingredient mixture 205, then the edges 202 of the first softened round rice paper 201 are folded and pressed snuggly over the edges 204 of the second rice paper 203 to form a circular pouch 206 to tightly enclose the salad mixture 205 in the middle to form the round wrapped salad portion patty 209 that is to be removed from template 200.

FIG. 7 shows a cross-sectional view of the separated round wrapped salad portion patty 209 comprising pouch 206 formed by the fusion of edges 202 of the first softened rice paper 201 with the edges 204 of the second softened rice paper 203 and enclosing the salad ingredient mixture 205 and salad dressing 208.

A non-limiting illustrative example for the preparation of a wrapped salad portion of the sandwich product by the method using two softened round rice papers of significantly different dimensions as depicted by FIGS. 5 to 7 comprises a first round rice paper of a diameter of about 19.5 cm and a second round rice paper of a diameter of about 10 cm to form an squat round enclosure to contain about 80 g of a salad mixture resulting in a round wrapped salad portion patty with a diameter of about 10 cm in diameter and a thickness of about 4 cm.

FIG. 8 shows an embodiment of the wrapper sandwich product 270, especially a fast food wrapped sandwich product, wherein the wrapped sandwich product comprises the edible wrapper 201 enclosing one or more salad ingredients 205, salad dressing 208, and a meat or protein portion 250. The wrapper sandwich product 270 is made substantially the way the wrapped salad portion patty 209 is made, except that a meat patty portion 250 is placed in with the one or more salad ingredients 205, prior to folding and sealing the meat patty portion 250 and the one or more salad ingredients 205 within the edible wrapper 201. The meat or protein portion 250 can be placed in beneath, on top of, and within the layer of salad ingredients 205.

In this embodiment wherein the wrapped salad portion comprises two softened approximately round rice papers of significantly different dimensions, the larger round rice paper has a diameter of from about 17 cm to about 23 cm, and the smaller round rice paper has a diameter of from about 7 cm to about 13 cm.

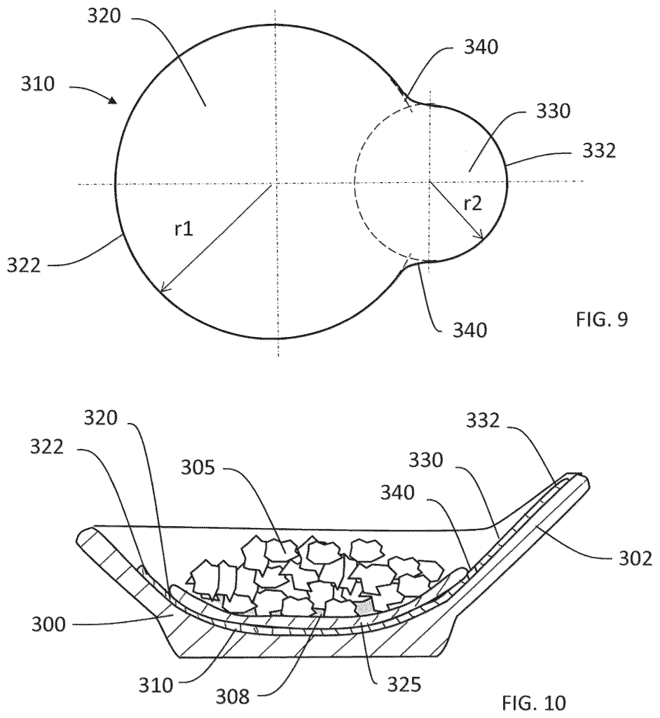

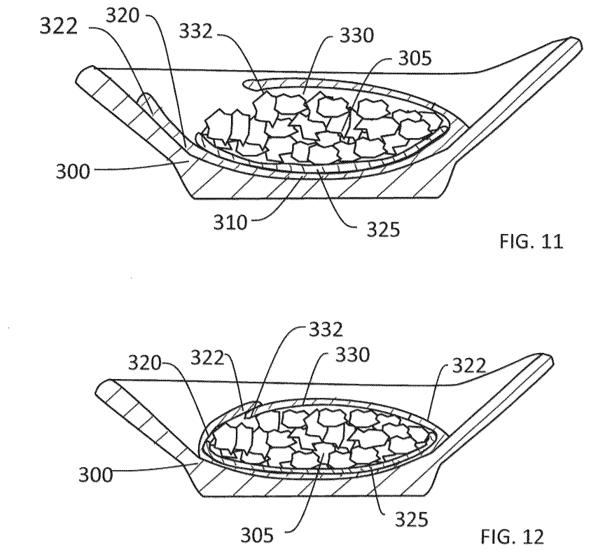

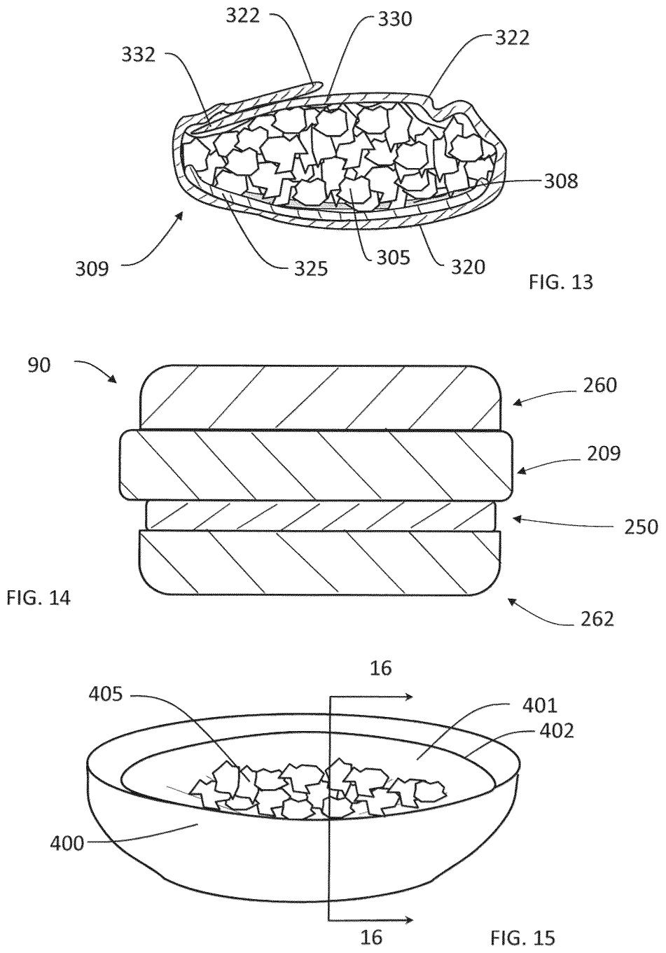

An alternative embodiment is a method to prepare a rice paper wrapped salad portion (or a wrapped sandwich product) using an edible, pre-cut flap wrapper made of a softened rice paper, comprising an approximately round portion and an integral flap portion extending from the round portion, as illustrated in FIGS. 9 to 13 . . . . The edible flap wrapper 310 comprises a substantially circular portion 320 having a circular periphery 322, and an integral or fused auxiliary flap portion 330, extending from a portion of the periphery 322, and having a rounded distal periphery 332. A shoulder portion 340 is formed at each intersection of the curvatures of the substantially circular portion 320 and the integral auxiliary flap portion 330, to eliminate any acute edges and corners that may tear more easily. A method of using the flap wrapper 310 comprises the steps of (1) moistening the flap wrapper for use as an outer wrapper layer; (2) placing the larger circular portion 320 of the flap wrapper rice paper in a concave template 300 having a rim extension 302 to accommodate the flap portion 330 (FIG. 10); (3) optionally placing a rounded piece of iceberg lettuce 325 as an inner wrapper layer at the middle of the larger circular rice paper portion 330; (4) selecting and placing the salad ingredient mixture 350 at the middle of larger circular portion 320 of the flap wrapper rice paper (FIG. 10); (5) optionally pouring a salad dressing 308 on the salad ingredient mixture 305; (6) folding and laying the integral flap portion 330 of rice paper on top of the salad ingredient mixture 305 (FIG. 11); (7) folding and pressing snuggly the edges 322 of the larger circular portion 320 over the edge 332 of the integral flap portion 330 to form a circular, covered pouch to tightly enclose the salad ingredient mixture 305 in the middle to form the round wrapped salad portion patty (FIG. 12); and (8) releasing the round wrapped salad portion patty 309 from the template 300 (FIG. 13). In this embodiment and method, the radius r2 of the integral flap portion 330 is about one half the radius r1 of the larger circular portion 320, with the center of the pattern of the flap portion 330 disposed on the periphery 322 of the pattern of the larger circular portion 320. For example, the diameter of the larger circular portion can be 20 cm, the diameter of the integral flap portion can be 10 cm, and the longest dimension from the periphery of the larger circular portion to the periphery of the flap portion can be 25 cm.

An alternative embodiment to any of the preceding embodiments, an edible processed wrapper, such as rice paper, and an edible natural wrapper, such as lettuce leaf, are used together to form a wrap containment. The rice paper is used as the main outer layer and a smaller, trimmed, round lettuce leaf forms an inner layer placed in a center portion of the rice paper. The use includes placing the edible natural wrapper, such as a lettuce or cabbage leaf, over the center portion of the larger softened rice paper, before placing the salad ingredient mixture thereupon. The additional layer of edible natural wrapper provides an improved barrier to liquid, including any salad dressing or liquid garnish. This arrangement allows the addition of a copious amount of salad dressing, especially a thin, low viscosity salad dressing directly to the salad ingredient mixture, without the risk of the salad dressing over-softening the rice paper and causing a leak of the salad dressing through the rice paper layer. The main outer layer wrapper can include one or more wrapper elements used in combination, and can be of any size or shape that can cover substantially the salad ingredient portion and other contents, including any of the edible processed wrapper elements described herein.

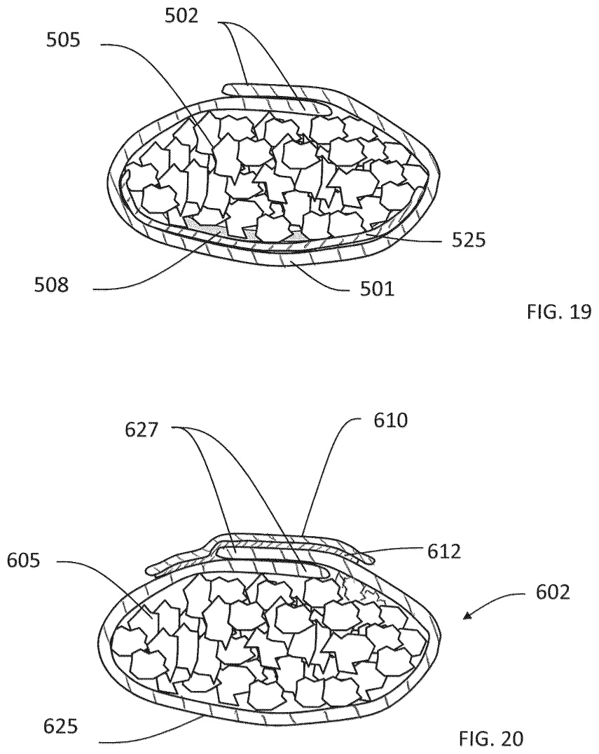

FIGS. 18-19 show a wrapped salad portion with one large, softened round rice paper, comprising a concave template 500 holding relative larger softened round rice paper 501 having edges 502, and a lettuce leaf wrapper 525 covering the middle of the rice paper 501. A heap of salad ingredient mixture 505 and a salad dressing 508 are placed upon the lettuce leaf 525, separating the salad ingredients from the rice paper. Cross-sectional view FIG. 19 shows the wrapper salad portion removed from the template 500.

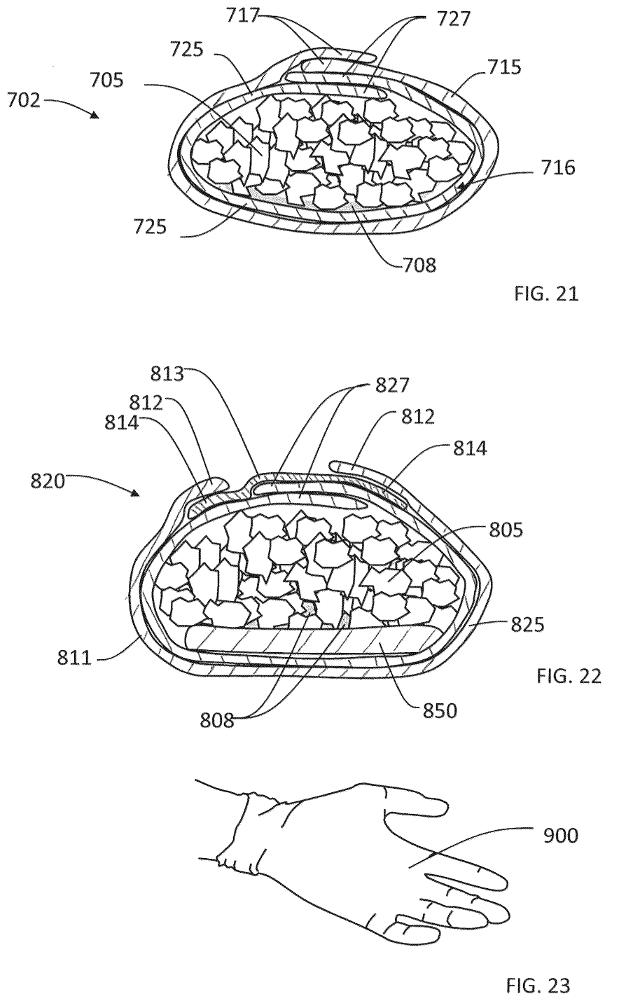

Another embodiment of the present invention is a wrapped salad product or a wrapped sandwich product comprising an inner lettuce leaf wrapper containing and enclosing a salad ingredient mixture, optional salad dressing, and optional meat or protein patty, and an outer softened rice paper that covers and overlays the inner lettuce wrapper, as illustrated in FIGS. 21 and 22. In this twice-wrapped sandwich product, the lettuce layer provides the strength and the softened rice paper layer provides the resiliency and integrity of the wrapped sandwich product. This twice-wrapped sandwich product is suitable for consumption without the sandwich bun or bread portion.

FIG. 21 shows a cross-sectional view along a vertical plane of a twice-wrapped sandwich product 702 comprising a lettuce leaf 725 containing a quantity of salad ingredient mixture 705 and salad dressing 708. The edges 727 of lettuce leaf 725 are overlaid to enclose the salad ingredient mixture 705 and salad dressing 708 to form an inner lettuce salad wrap 716. This inner lettuce salad wrap 716 is covered by a softened rice paper wrapper 715 wherein the extending edges 717 of the rice paper wrapper 715 are folded over the lettuce salad wrap and keep the lettuce leaf edges 727 pressed together, and keep them from unfolding. In this twice-wrapped sandwich product, the lettuce layer provides the strength and the softened rice paper layer provides the resiliency and integrity of the wrapped salad product. The outer processed wrapper can include one or more wrapper elements used in combination, and can be of any size or shape that can cover substantially the entire outside surface of the inner lettuce salad wrap, including any of the edible processed wrapper elements described herein.

FIG. 22 shows a cross-sectional view along a vertical plane of a twice-wrapped sandwich product 820 comprising a lettuce leaf 825 comprising edges 827 and containing a quantity of a salad ingredient mixture 805, a salad dressing 808, and a meat patty 850. The edges 827 of the lettuce leaf 825 are overlaid to enclose the salad ingredient mixture 805, the salad dressing 808, and the meat patty 850 to form an inner lettuce salad wrap 816. This inner lettuce salad wrap 816 is covered by a first softened round rice paper wrapper 811 comprising edges 812 and a second softened round rice paper 813 comprising edges 814, wherein the edges 812 of the first softened rice paper 811 are folded and pressed snuggly over the edges 814 of the second softened rice paper 813 to tightly enclose the lettuce salad wrap 816 and to keep the lettuce leaf edges 827 pressed together, and keep them from unfolding. In this twice-wrapped sandwich product, the lettuce layer provides the strength and the softened rice paper layer provides the resiliency and integrity of the wrapped salad product.

### Preparation of a Combination Sandwich

Typically, the preparation of a combination sandwich 90, illustrated in FIG. 14, comprises the steps of (1) slicing a sandwich bun into two halves 260 and 262 or using a pre-sliced sandwich bun with two halves 260 and 262; (2) removing the top half 260 of the sandwich bun; (3) placing a meat or protein portion 250 on the bottom half 262 of the sandwich bun; (4) placing a wrapped salad portion 209 on top of the meat or protein portion 250; and (5) placing the top half 260 of the sandwich bun back on top of the wrapped salad portion to secure the salad portion. The order of components from bottom to top of a combination sandwich, with the flat bottom bun part placed in the bottom, then the meat or protein portion layer, the salad portion layer, then the top bun part is believed to provide a best tasting product, because the tongue of a consumer would touch the tasty meat before a blander salad.

In a fast food restaurant, one way to prepare a combination sandwich from a regular fast food sandwich that is already completely prepared includes simply the removal of the top part of the hamburger bun of the sandwich to place the wrapped salad portion on top of the meat or protein portion, and the replacement of the top part of the hamburger bun back on top of the wrapped salad portion.

The combination sandwich product is preferably provided in association with directions for the consumer to consume the sandwich in the best way to avoid spillage. The eater is directed to hold the sandwich in the manner of having the open end of the salad pocket pointing upwards like holding a cup, after the first bite, such that all salad ingredients are contained insides the sandwich without spilling or leaking. This way salad can be conveniently consumed along with the bread portion and the meat or protein portion without a need for extra utensils.

A major advantage of a combination sandwich product of this invention is the minimization of messy spills, especially with finely divided salad ingredients and garnishes that normally would not be added to a sandwich and/or would not be added in sufficient quantity to provide the desired tasteful healthy meal. Another major advantage is the ability to provide healthier and more nutritious products, even in a combined sandwich and salad combination. Yet another major advantage is the ability to conveniently consume a large amount of a salad mixture along with the sandwich product without having to use utensils. Another advantage of a combination sandwich is that it allows a consumer to hold the sandwich in a more natural hand position, in which the sandwich is in a substantially vertical position without the concern that the salad content will spill, and the consumer's neck is in the straight vertical position while consuming the sandwich, while a regular sandwich containing any voluminous content requires to be held in a more or less horizontal position with more awkward hand position to avoid a content spillage, and the consumer's neck needs to bend backward to consume such sandwich.

### Edible Humectant

In another aspect of the invention, a method is provided for improving the resistance to drying of a moistened rice paper, used in the preparation of a wrapper salad portion. The method comprises the step of adding an edible humectant into a source of water used for moistening a dried sheet of a rice paper, and moistening the rice paper in the source of water comprising the edible humectants. The edible humectant is selected from the group consisting of glycerol, propylene glycol, sorbitol, and a mixture thereof. The edible humectant can be comprised in the aqueous solution at a mass concentration from about 0.1% to about 5%, including from about 0.2% to about 2%, humectant in water. Any conventional method of preparing, dispensing and mixing the edible humectants into the water source can be used.

The invention also provides a method for preparing a wrapped salad portion or wrapped sandwich product, comprising the steps: (1) providing the moistened rice paper comprising the edible humectant, optionally onto a flat or concave surface of a template; (2) placing a plurality of salad ingredients into a heap in a middle portion of the moistened rice paper; (3) optionally adding a salad dressing to the salad ingredients; (4) folding an edge of the moistened rice paper over the salad ingredients, to fully enclose the salad ingredients within the moistened rice paper to form the wrapped salad portion; and optionally (5) releasing the wrapped salad portion from the template.

### Salad Dressing Injection

In a further embodiment of the invention, a method is provided for insertion of a salad dressing or other flowable liquid into a wrapped salad portion, using a manual or automated injection device. The injection device provides a method for injecting a salad dressing into a wrapped salad portion, described herein, after its assembly and preparation; that is, after an edible wrapper, for example, the softened rice paper, has been wrapped around a salad ingredient mixture and its edges pressed together and closed. The wrapped salad portion can have a form of a flattened mass having an approximate square form or an approximation of a round form, wherein the salad dressing has a short vertical axis and multiple long horizontal axes that are perpendicular to the vertical axis.

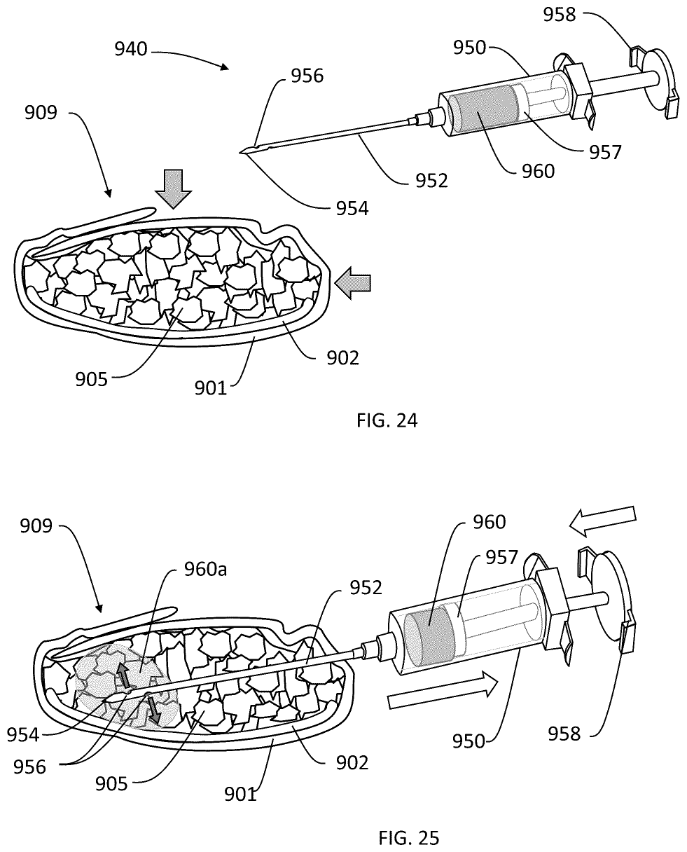

FIGS. 24 and 25 show the method of the present invention for insertion of a fluid salad dressing into the wrapped salad portion. FIG. 25 shows, for the purposes of illustration and without limitation, a wrapped salad portion 909 that is similar to the wrapped salad portion 309 of FIG. 24 and an injection device 940. A salad ingredient mixture 905 is contained in a layered edible wrapper comprising a moistened rice paper 901 and a rounded portion of an iceberg lettuce leaf 902. The injection device can include a manually-operated syringe 940, have a cylinder 950, plunger assembly 958 having a plunger 957 insertable into one end of, and movable within, the cylinder 950, and an insertable needle 952. The needle 952 is attached to the other end of the cylinder 950, typically with a luer fitting. The needle 952 has a distal end 954 having a sharp tip for inserting easily into the interior of the wrapper salad portion. The needle can include one or more of a lateral port 956, typically near the tip-end 954 of the needle 952, in fluid communication with the interior passage of the needle, to allow the salad dressing 960 to exit radially outwardly from the port(s) 956 and into the surrounding salad ingredient mixture 905, as shown in FIG. 25, when the plunger 957 is depressed and moved along the interior length of the cylinder. The distal end 954 is usually closed to prevent excessive depositing of dressing along the path of insertion or withdrawal. The lateral ports are large enough in size or diameter to allow a viscous dressing or a dressing containing small solids (for example, seeds) to pass through easily and without excessive fluid resistance. The syringe can be inserted along the long axis of the wrapped salad portion 909, usually inserted inwardly from a side as shown in FIG. 25, including approximately along a long horizontal axis of the wrapped salad portion, or inwardly through the top, as shown by the two gray arrows in FIG. 24.

In an aspect of the invention, the method comprises the steps of: a. providing an injector device comprising at least one needle including a tip and at least one lateral port near the tip, wherein the injector device contains a salad dressing; b. inserting the tip of the at least one needle of the injector device into the wrapped salad portion; c. expressing a volume of the salad dressing from the injector device through the at least one lateral port to the interior of the wrapped salad portion; and d. removing the at least one needle from the wrapped salad portion.

In a further aspect, a method provides for placing a volume of salad dressing into a sealed and wrapped salad portion using the multi-needle injector device containing a salad dressing. Typically the wrapped salad portion comprises salad ingredients and a thin, edible wrapper enclosing the salad ingredients, and has a form of a flattened mass having an approximate square form or an approximation of a round form. The method comprises the steps of: a. inserting the plurality of needles through the top side of the wrapped salad portion; b. expressing a volume of the salad dressing from the plurality of needles to the interior of the wrapped salad portion; and c. removing the plurality of needles from the wrapped salad portion.

In one method of the invention, the needle 952 is sufficiently long to permit the insertion of the needle 952 in one side along a long axis of the wrapped salad portion 909 so that the tip 954 extends almost to the opposite side. FIG. 25 illustrates how the user can slowly withdraw the needle, while expressing salad dressing from the lateral ports 956, to inject a volume of the salad dressing 960 into more of the volume of the salad ingredient mixture 905 and along the inside length of the wrapped salad portion 909.

In a method of the invention for placing a volume of salad dressing into a sealed and wrapped salad portion, as described herein, an injector device is provided that comprises a cylinder, a plunger assembly including a plunger moveable along the interior length of the cylinder, and a needle attached to an outlet at the outlet end of the cylinder, wherein the needle has a sharp tip and at least one lateral port near the tip. The plunger of the injector device is removed and the cylinder of the injector device is filled with a fluid salad dressing, and the plunger is reinstalled into the cylinder. The dressing can be drawn up into the cylinder through the outlet end of the cylinder, and the needle is attached. The tip of the needle of the injector device is then inserted into the wrapped salad portion at an insertion point on an outer layer of a wrapped salad portion. The point of entry and path of insertion can be varied based upon the size and shape of the wrapped salad portion, and the assembly conditions and requirements. The tip of the needle is typically inserted sufficiently deep into the wrapped salad portion, and to a position inside the wrapped salad portion, opposite the insertion point. The user then causes the plunger to move along the interior length of the cylinder, by actuating or depressing the plunger, which expresses the fluid salad dressing from the cylinder interior and out through the lateral ports. By depressing the plunger while withdrawing the tip of the needle from the opposite position toward the insertion point, a volume of the salad dressing is injected into the volume of the salad ingredient mixture along the path. The needle is then removed from the wrapped salad portion.

Multiple insertions and injections of dressings can also be performed. These multiple needle insertions can be made by a single needle, inserted numerous times to inject dressing along numerous pathways.

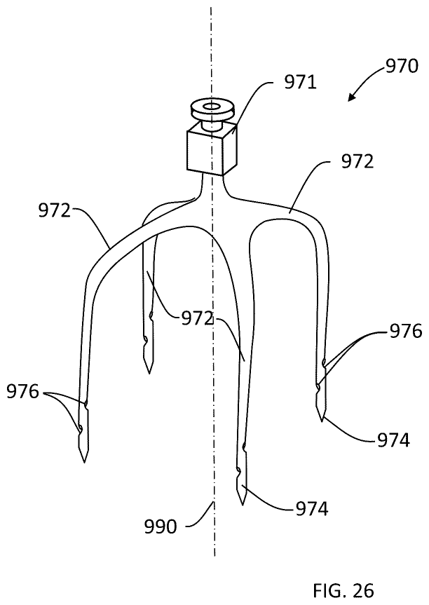

Multiple insertions and injections of dressings can be achieved, e.g., by multiple-needle arrangement, such as an injection device with multiple needles as illustrated in FIG. 26. FIG. 26 shows a multi-needle device 970 having an inlet port 971 to be attached to a salad dressing distributing source, such as a syringe, and a plurality of single needles 972 connecting in fluid communication to, and extending outwardly from inlet port 971, wherein each single needle 972 has a sharp tip 974 and one or more lateral port(s) 976 typically near the end of tip 974. The multiple needles are typically arranged to extend parallel with each other needle and with an axis 990 through the port 971. In one embodiment, the plurality of needles can extend equidistantly from and radially surrounding the port 971 and the axis 990. In another embodiment, the plurality of needles can extend along in a linear series. The multi-needle device 970 can be inserted through the broader top side of a wrapped salad portion to inject a salad dressing quickly and readily into the volume of the salad ingredient mixture in the interior of the wrapped salad portion.

While a manually-operating injector device is shown and described in use, it would be within the scope of the invention and the skill of one of ordinary skill to mechanize and/or automate the injection of salad dressing to a wrapped salad portion, employing power, control and mechanical systems and supports by well known means. A needle arrangement such as 970 is particularly suitable for mechanized and/or automatic injection of salad dressing into wrapped salad portions.

### EXAMPLES

Following are examples of the wrapped salad portion of the invention, which include a wrapper material that contains a salad ingredient mixture, wherein all weights are approximate.

Example 1. A wrapped salad portion is prepared according to FIGS. 15-17 using a fresh iceberg lettuce wrapper and comprising the following ingredients:

| | |
|---|---|
| Fresh iceberg lettuce leaf wrapper | 41 g |
| Garbanzo beans | 20 g |
| Chopped iceberg lettuce | 29 g |
| Salad dressing | 15 g |

Example 2. A wrapped salad portion is prepared according to FIGS. 15-17 using an iceberg lettuce leaf that is microwaved for about 20 seconds and comprising the following ingredients:

| | | |
|---|---|---|
| Microwaved iceberg lettuce leaf wrapper | 45 | g |
| Chopped iceberg lettuce | 16 | g |
| Spring mix | 5 | g |
| Cubed tomato | 15 | g |
| Garbanzo beans | 11 | g |
| Chopped onion | 4 | g |
| Sliced red and yellow bell pepper | 10 | g |
| Pepper-stuffed green olives | 5 | g |
| Salad dressing | 20 | g |

Example 3. A wrapped salad portion is prepared according to FIGS. 15-17 and 20 using an iceberg lettuce wrapper and a round rice paper patch of about 10 cm in diameter and a dry weight of about 1.8 g, and coated with a 1% xanthan gum binder, and comprising the following ingredients:

| | | |
|---|---|---|
| Steamed iceberg lettuce leaf wrapper | 45 | g |
| Rice paper patch | 1.8 | g |
| Spring mix | 18 | g |
| Cherry tomatoes | 17 | g |
| Bacon bits | 6 | g |
| Walnut | 7 | g |
| Sliced jalapeño pepper | 7 | g |
| Sliced black olives | 5 | g |
| Salad dressing | 18 | g |

Example 4. A wrapped salad portion is prepared according to FIGS. 15-17 using a softened round rice paper wrapper of about 25 cm in diameter and a dry weight of about 11 g and comprising the following ingredients:

| | | |
|---|---|---|
| Rice paper wrapper | 11 | g |
| Chopped iceberg lettuce | 21 | g |
| Spring mix | 9 | g |
| Radicchio | 6 | g |
| Cubed tomato | 10 | g |
| Garbanzo beans | 8 | g |
| Shredded mozzarella cheese | 11 | g |
| Salad dressing | 15 | g |

Example 5. A wrapped salad portion is prepared according to FIGS. 1-4 using a softened round rice paper wrapper of about 19.5 cm in diameter and a dry weight of about 6.2 g and a softened round rice paper wrapper of about 16 cm in diameter and a dry weight of about 4.2 g and comprising the following ingredients:

| | | |
|---|---|---|
| Rice paper wrappers | 10.4 | g |
| Chopped iceberg lettuce | 25 | g |
| Spring mix | 9 | g |
| Shredded carrot | 4 | g |
| Halved cherry tomatoes | 13 | g |
| Sliced red bell pepper | 8 | g |
| Sliced dried cranberries | 8 | g |
| Salad dressing | 13 | g |

Example 6. A wrapped salad portion is prepared according to FIGS. 5-7 using a softened round rice paper wrapper of about 19.5 cm in diameter and a dry weight of about 6.2 g and a softened round rice paper wrapper of about 10 cm in diameter and a dry weight of about 1.8 g and comprising the following ingredients:

| | | |
|---|---|---|
| Rice paper wrappers | 8 | g |
| Shredded Savoy cabbage | 25 | g |
| Shredded green cabbage | 20 | g |
| Shredded carrot | 7 | g |
| Chopped green onion | 3 | g |
| Cilantro | 3 | g |
| Sliced toasted almonds | 3 | g |
| Total weight | 72 | g |
| Salad dressing | 15 | g |

Example 7. A wrapped salad portion is prepared according to FIGS. 9-13 using a softened flap rice paper wrapper with the diameter of the larger circular portion of about 20 cm and the diameter of the integral flap portion of about 10 cm, said flap rice paper wrapper having a dry weight of about 7.3 g, an inner iceberg lettuce wrapper of diameter of about 12 cm and a weight of about 9 g and comprising the following ingredients:

| | | |
|---|---|---|
| Rice paper wrapper | 7.3 | g |
| Inner iceberg lettuce wrapper | 9 | g |
| Chopped iceberg lettuce | 22 | g |
| Spring mix | 9 | g |
| Shredded carrot | 6 | g |
| Sliced roasted tomatoes | 7 | g |
| Roasted garlic | 5 | g |
| Chopped green onion | 4 | g |
| Salad dressing | 17 | g |

Example 8. A wrapped salad portion is prepared according to FIGS. 15-17 using a green cabbage leaf that is steamed for about 3 minutes and comprising the following ingredients:

| | | |
|---|---|---|
| Steamed green cabbage leaf | 49 | g |
| Chopped iceberg lettuce | 22 | g |
| Chopped ham | 20 | g |
| Chopped boiled egg | 7 | g |
| Chopped green onion | 3 | g |
| Salad dressing | 12 | g |

Example 9. A wrapped salad portion is prepared according to FIGS. 15-17 using a green cabbage leaf that is first sprayed with a PAM® cooking spray then heated in a microwave oven for about 1 minute and comprising the following ingredients:

| | | |
|---|---|---|
| Microwaved green cabbage leaf | 50 | g |
| Sliced iceberg lettuce | 10 | g |
| Chopped tomatoes | 8 | g |
| Sliced red and yellow pepper | 6 | g |
| Chopped fresh mushroom | 10 | g |
| Garbanzo beans | 10 | g |
| Small pepper-stuffed green olives | 8 | g |
| Bacon bits | 5 | g |
| Salad dressing | 15 | g |

Each of the 9 wrapped salad portions is incorporated into commercial fast food sandwiches by adding the wrapped salad portion beneath the top bread layer. Said sandwiches are either: 1. a McDonalds' quarter pounder; 2. a McDonalds' quarter pounder with cheese; 3. a Wendy's “¼ lb simple” hamburger; 4. a Burger King's Whopper containing only the hamburger buns and the cooked beef patty; or 5. an Arby's roast beef sandwich to make 45 different combination sandwich/samples.

The combination of regular sandwiches and the wrapped salad portions provide products that improve the healthiness and acceptability of the combination sandwiches as opposed to the plain sandwiches for applicant's children who were too busy to eat a normal regular meal.

Example 10. A twice-wrapped salad product is prepared according to FIG. 21 using a softened round rice paper wrapper of about 25 cm in diameter and a dry weight of about 11 g and an iceberg lettuce leaf that is microwaved for about 10 seconds, and this twice-wrapped salad product comprises the following ingredients:

| | | |
|---|---|---|
| Rice paper wrapper | 11 | g |
| Microwaved iceberg lettuce leaf | 42 | g |
| Spring mix | 10 | g |
| Halved cherry tomatoes | 10 | g |
| Shredded carrot | 6 | g |
| Sliced jalapeño pepper | 7 | g |
| Pepper-stuffed green olives | 5 | g |
| Grated parmesan cheese | 8 | g |
| Bacon bits | 5 | g |
| Salad dressing | 15 | g |

Example 11. A twice-wrapped sandwich product is prepared according to FIG. 22 using a softened round rice paper wrapper of about 21 cm in diameter and a dry weight of about 7.2 g and a smaller softened round rice paper wrapper of about 11 cm in diameter and a dry weight of about 2 g, and an iceberg lettuce leaf that is microwaved for about 10 seconds, and this twice-wrapped sandwich product comprises the following ingredients:

| | | |
|---|---|---|
| Rice paper wrappers | 9.2 | g |
| Microwaved iceberg lettuce leaf | 44 | g |
| Meat patty | 51 | g |
| Spring mix | 10 | g |
| Chopped tomatoes | 8 | g |
| Sliced jalapeño pepper | 7 | g |
| Pepper-stuffed green olives | 5 | g |
| Blue cheese crumbs | 8 | g |
| Salad dressing | 15 | g |

The above description discloses, by way of example, some typical embodiments of the present invention. However, persons of ordinary skill in the art are capable of creating numerous modifications within the scope of the claims. Changes in specifics of form and details can be made to the above-described embodiments. The claims and not the examples are the measure of the protected invention.

Because the instant application is a continuation application, to the extent any amendments, characterizations, or other assertions previously made (in any related patent applications or patents, including any parent, sibling, or child) with respect to any art, prior or otherwise, could be construed as a disclaimer of any subject matter supported by the present disclosure of this application, Applicants hereby rescind and retract such disclaimer. Applicants also respectfully submit that any prior art previously considered in any related patent applications or patents, including any parent, sibling, or child, may need to be re-visited.

1. A wrapped salad portion comprising a heap of salad ingredients and a thin, edible natural wrapper enclosing the heap of salad ingredients, the wrapped salad portion having a form of a flattened mass having an approximately square form or an approximately round form, in the shape of a thick square or round patty, wherein the edible natural wrapper is selected from the group consisting of one or more of a lettuce leaf, an iceberg lettuce leaf, a cabbage leaf, and a combination thereof; wherein
the heap of salad ingredients comprises salad ingredients that are selected from the group consisting of chopped lettuce, cut up lettuce, shredded lettuce, wherein lettuce is selected from the group consisting of iceberg lettuce, green romaine lettuce, red romaine lettuce, green leaf lettuce, red leaf lettuce, Boston lettuce, and a combination thereof; fresh spinach, chopped fresh spinach, fresh baby spinach leaves; spring mix comprising one or more of baby red romaine, baby green romaine, baby red leaf, baby green leaf, baby red Swiss chard, baby red oak, baby green oak, parella, lolla rosa, tango, tot soi, arugula, mizuma, radicchio, or frisee; edible dandelions; shredded green cabbage, shredded red cabbage, shredded savoy cabbage; shredded carrots, thinly sliced carrots; cut up celery; sliced cucumber; chopped onion; sliced onion; chopped green onion; chopped scallions; sliced radishes; shredded radishes; chopped cilantro; chopped mints; chopped basil; sliced dill pickles; sliced bell pepper selected from sliced green bell pepper, sliced red bell pepper, sliced yellow bell pepper, red pepper, and mixtures thereof; jalapeño slices; olives selected from sliced black olives, pepper-stuffed green olives, and mixtures thereof; sliced or chopped fresh mushroom; chopped boiled egg, tomatoes selected from chopped tomatoes, cherry tomatoes, grape tomatoes, sun-dried tomatoes, boiled corn kernels; sliced roasted tomatoes, and mixtures thereof; garlic or roasted garlic; seedless grapes; raisins; maraschino cherries; chopped pineapple; cheese selected from grated cheese, grated parmesan cheese, shredded cheddar cheese, shredded mozzarella cheese, blue cheese crumbs, and mixtures thereof; green peas; garbanzo beans or chick-peas; red beet slices; bean sprouts; broccoli pieces; cauliflower pieces; cut up asparagus; bacon bits, seeds and nuts selected from sunflower kernels, chopped pistachios, sliced toasted almonds, pecan, walnuts, pumpkin seeds, and mixtures thereof; prepared meat selected from chopped sausage, chopped bologna, chopped ham, chopped chicken, and a combination thereof; thick sauce; creamy sauce; salad dressing; and a combination thereof; and wherein
the wrapped salad portion optionally further includes a meat or protein portion, selected from the group consisting of one or more of a beef hamburger patty, one or more of sliced cheese, one or more of sliced ham, one or more of a chicken meat portion, one or more of sliced turkey, one or more of sliced roast beef, fish, and one or more of textured vegetable protein patty, and combinations thereof, wherein the edible natural wrapper encloses the heap of salad ingredients and the meat or protein portion.

2.-5. (canceled)

6. A sandwich product combining a meat or protein portion layer and a wrapped salad portion layer comprising a wrapped salad portion,
the wrapped salad portion having a form of a flattened mass having an approximately square form or an approximately round form, with a shape of a thick square or round patty, comprising a heap of salad ingredients and a thin, edible natural wrapper enclosing the heap of salad ingredients, the edible natural wrapper selected from the group consisting of one or more of a lettuce leaf, an iceberg lettuce leaf, a cabbage leaf, and a combination thereof,
wherein the meat or protein portion layer is not wrapped; and
wherein the meat or protein portion layer and the wrapped salad portion layer are disposed between a bread portion, the bread portion including at least two slices of bread or a sliced hamburger bun.

7. (canceled)

8. The sandwich product according to claim 6 wherein the meat or protein portion is selected from one or more of the group consisting of a cooked meat patty, a beef hamburger patty, a veal burger patty, a venison burger patty, a bison burger patty, a chicken patty, a turkey patty, a fish patty, sliced roast beef, sliced turkey, sliced chicken, sliced ham, sliced bologna, textured vegetable protein patty, one or more slice s of cheese, patty-shaped cooked egg, and a combination thereof; and
the heap of salad ingredients comprises salad ingredients selected from the group consisting of chopped lettuce, cut up lettuce, shredded lettuce, wherein lettuce is selected from the group consisting of iceberg lettuce, green romaine lettuce, red romaine lettuce, green leaf lettuce, red leaf lettuce, Boston lettuce, and a combination thereof; fresh spinach, chopped fresh spinach, fresh baby spinach leaves; spring mix comprising one or more of baby red romaine, baby green romaine, baby red leaf, baby green leaf, baby red Swiss chard, baby red oak, baby green oak, parella, lolla rosa, tango, tot soi, arugula, mizuma, radicchio, or frisee; edible dandelions; shredded green cabbage, shredded red cabbage, shredded savoy cabbage; shredded carrots, thinly sliced carrots; cut up celery; sliced cucumber; chopped onion; sliced onion; chopped green onion; chopped scallions; sliced radishes; shredded radishes; chopped cilantro; chopped mints; chopped basil; sliced dill pickles; sliced bell pepper selected from sliced green bell pepper, sliced red bell pepper, sliced yellow bell pepper, red pepper, and mixtures thereof; jalapeño slices; olives selected from sliced black olives, pepper-stuffed green olives, and mixtures thereof; sliced or chopped fresh mushroom; chopped boiled egg, tomatoes selected from chopped tomatoes, cherry tomatoes, grape tomatoes, sun-dried tomatoes, boiled corn kernels; sliced roasted tomatoes, and mixtures thereof; garlic or roasted garlic; seedless grapes; raisins; maraschino cherries; chopped pineapple; cheese selected from grated cheese, grated parmesan cheese, shredded cheddar cheese, shredded mozzarella cheese, blue cheese crumbs, and mixtures thereof; green peas; garbanzo beans or chick-peas; red beet slices; bean sprouts; broccoli pieces; cauliflower pieces; cut up asparagus; bacon bits, seeds and nuts selected from sunflower kernels, chopped pistachios, sliced toasted almonds, pecan, walnuts, pumpkin seeds, and mixtures thereof; prepared meat selected from chopped sausage, chopped bologna, chopped ham, chopped chicken, and a combination thereof; thick sauce; creamy sauce; salad dressing; and a combination thereof.

9.-13. (canceled)

14. The wrapped sandwich product according to claim 6, wherein a moistened banh trang encloses the edible natural wrapper.

15.-20. (canceled)

21. The wrapped sandwich product according to claim 6, wherein the heap of salad ingredients further includes a salad dressing.

22.-23. (canceled)

24. The wrapped sandwich product according to claim 6, wherein the edible natural wrapper has adjacent edges that are overlapped to contain the heap of salad ingredients, and wherein the wrapped salad portion layer further includes a sticker layer comprising a portion of a moistened banh trang and a natural edible adhesive, wherein the sticker layer is adhered to the overlapped edges of the edible natural wrapper.

25. (canceled)

26. A method for preparing a wrapped salad portion, comprising the steps:
(1) providing an edible natural wrapper selected from the group consisting of one or more of a lettuce leaf, an iceberg lettuce leaf, a cabbage leaf, and a combination thereof;
(2) placing the edible natural wrapper on a flat or concave surface of a template;
(3) placing a heap of salad ingredients into a middle portion of the edible natural wrapper;
(4) optionally adding a meat or protein portion to the heap of salad ingredients;
(5) optionally adding a salad dressing to the heap of salad ingredients;
(6) folding at least one edge of the edible natural wrapper over the heap of salad ingredients to overlap at least one other edge of the edible natural wrapper, to fully enclose the heap of salad ingredients within the edible natural wrapper to form the wrapped salad portion; and
(7) releasing the wrapped salad portion from the template.

27. (canceled)

28. The method according to claim 26, wherein the step of folding includes the steps of folding and overlapping a first two of opposed edges of the edible natural wrapper, followed by folding and overlapping of a remaining two of opposed edges over the first two opposed edges to fully enclose the heap of salad ingredients.

29. The method according to claim 26, wherein the step of folding includes the steps of folding and overlapping consecutively the adjacent edges to fully enclose the heap of salad ingredients.

30. (canceled)

31. The method according to claim 26, further including the step of placing a moistened banh trang over the heap of salad ingredients enclosed in the natural edible wrapper, wherein the step of folding comprises the steps of enclosing the heap of salad ingredients in the natural edible wrapper, then enclosing the edible natural wrapper in the moistened banh trang, to fully enclose the heap of salad ingredients to form the wrapped salad portion.

32. The method according to claim 31, wherein the moistened banh trang is freshly moistened and is still fairly rigid when placed on the heap of salad ingredients.

33.-53. (canceled)

54. The wrapped salad portion according to claim 1, wherein the edible natural wrapper is a first sheet of wrapper that encloses the heap of salad ingredients, and a moistened banh trang is a second sheet of wrapper that encloses the first sheet of wrapper.

55. The wrapped salad portion according to claim 1, wherein the edible natural wrapper is a second sheet of wrapper that encloses a first sheet of wrapper, the first sheet of wrapper being a moistened banh trang that encloses the heap of salad ingredients.

56. The wrapped salad portion according to claim 1, wherein the salad ingredients further comprise a salad dressing.

57. The wrapped salad portion according to claim 1, wherein the edible natural wrapper has at least four opposed edges that overlap to contain the heap of salad ingredients, and wherein the wrapped salad portion further comprises a sticker layer comprising a portion of a moistened banh trang and a natural edible adhesive, wherein the sticker layer is adhered to the overlapped edges of the edible natural wrapper.

58. The wrapped salad portion according to claim 1, wherein the natural edible wrapper is fresh.

59. The wrapped salad portion according to claim 1, wherein the natural edible wrapper is blanched.

60. The method according to claim 26, further including a step of placing a sticker layer over the heap of salad ingredients enclosed in the edible natural wrapper, wherein the sticker layer comprises a portion of a moistened banh trang and a natural edible adhesive, wherein the step of folding comprises the steps of enclosing the heap of salad ingredients in the natural edible wrapper, then applying the sticker layer over the overlapped edges of the edible natural wrapper, to form the wrapped salad portion.

61. The method according to claim 26, further providing a step, prior to step (2), of blanching the natural edible wrapper.
